(19) United States
(12) Patent Application Publication
(10) Pub. No.: US 2025/0362704 A1
(43) Pub. Date: Nov. 27, 2025

(54) KNOB ASSEMBLY AND COOKING APPARATUS HAVING SAME

(71) Applicant: LG ELECTRONICS INC., Seoul (KR)

(72) Inventors: SangHyeok Cho, Seoul (KR); Daebong Yang, Seoul (KR); Yik Soo Na, Seoul (KR)

(73) Assignee: LG ELECTRONICS INC., Seoul (KR)

(21) Appl. No.: 19/217,617

(22) Filed: May 23, 2025

(30) Foreign Application Priority Data
May 24, 2024 (KR) 10-2024-0067956
Oct. 22, 2024 (KR) 10-2024-0145027
Oct. 22, 2024 (KR) 10-2024-0145038
Apr. 2, 2025 (KR) 10-2025-0042995

(51) Int. Cl. G05G 5/00; F24C 15/00; G05G 1/08; G05G 5/05

(52) U.S. Cl. CPC G05G 5/005; F24C 15/00; G05G 1/082; G05G 5/05; G05G 2505/00

(57) ABSTRACT

A knob assembly includes a driving shaft configured to protrude from a control panel, a knob body configured to be rotated about the driving shaft and configured to be linearly moved in an axial direction along the driving shaft, a locking button having an operating portion exposed externally of the knob body, and a safety pin located at the locking button, the safety pin being configured to be operated in conjunction with the locking button, the safety pin having a first position and a second position, the second position being displaced from the first position in a direction different from the axial direction. At the first position, the safety pin is configured to restrict an axial movement of the knob body toward the control panel. At the second position, the safety pin is configured to allow the axial movement of the knob body toward the control panel.

### CROSS REFERENCE TO RELATED APPLICATION

The present application claims priority to Korean Patent Application No. 10-2024-0067956, filed May 24, 2024, Korean Patent Application No. 10-2024-0145027, filed May 24, 2024, Korean Patent Application No. 10-2024-0145038, filed Oct. 22, 2024, and Korean Patent Application No. 10-2025-0042995, filed Apr. 2, 2025, the entire contents of which are expressly incorporated herein.

### BACKGROUND OF THE INVENTION

### Field of the Invention

The present disclosure relates to a knob assembly and a cooking apparatus having the same.

### Description of the Related Art

A cooking apparatus is a device used to cook ingredients to make food. The cooking apparatus can also be used to heat food to the right temperature for consumption. The cooking apparatus may be classified in various ways according to the forms of heat sources used and the types of fuels. For example, the cooking apparatus may be categorized as open-type or sealed-type depending on the form of the space where food is placed. The sealed type cooking apparatus includes ovens and microwave ovens, and the open type cooking apparatus includes cooktops and griddles.

The sealed type cooking shields the space where ingredients are placed with doors and heats the shielded space to cook the food. The open type cooking apparatus is configured such that ingredients or a container storing ingredients is located in an open space and the ingredients or container is heated to cook ingredients to make food. In recent years, combination cooking apparatuses, which are a combination of sealed type and open type cooking apparatuses, has been used. The combination cooking apparatuses use a combination of heat sources to cook a variety of ingredients and can cook multiple foods simultaneously.

The cooking apparatus may be equipped with knobs for operation. The knob can be used to turn the cooking apparatus on or off, or to set cooking modes. Furthermore, the knob may be used to adjust a heating temperature.

In the cooking apparatus, for example a gas range, the knob may be manipulated in a push and turn manner to operate the cooking apparatus. The push and turn knob is implemented such that a user must hold it down and rotate the knob to operate the cooking apparatus. The user can adjust a heating temperature or select a cooking mode by pressing the knob and adjusting the amount of rotation on a drive shaft. The push and turn knob increases the safety of the cooking apparatus by requiring both steps to operate the cooking apparatus.

However, the push and turn knob also protrudes outward, so it's possible for users to rotate the knob while unintentionally pressing the knob. For example, without recognition of the user, the user's body touches the knob to press the knob and rotate the knob. Furthermore, it is also possible for a toddler to operate the knob to start the cooking apparatus. As described above, this can lead to fire or burns to the user, so it is important to increase the stability of the cooking apparatus.

### SUMMARY OF THE INVENTION

The present disclosure is provided to solve the above-described problems of the related art, and an objective of the present disclosure is to provide a knob assembly having a locking button (safety button), and prevent the knob assembly from being operated when the locking button is not pressed.

Another objective of the present disclosure is to form a moving direction of a locking button different from a rotating direction and a pressing direction of a knob assembly.

Yet another objective of the present disclosure is to simplify a structure of knob assembly by minimizing the number of parts added due to a locking button.

Still another objective of the present disclosure is to form a locking button to be used selectively by holding the locking button at a specific position by a button holder.

Still another objective of the present disclosure is to allow rotation of a button holder to be performed independently from a knob body and a locking button.

Still another objective of the present disclosure is to prevent a button holder from being exposed outward when a knob assembly is mounted to a cooking apparatus, and the like.

In order to achieve the above-described objectives, the knob assembly of the present invention may include a base portion disposed on a control panel and a driving shaft protruding from the control panel. The knob assembly may be equipped with a knob body that rotates about the driving shaft and moves linearly in the axial direction of the driving shaft.

The knob body may be provided with a locking button having an operating portion exposed to the outside. A safety pin may be disposed on the locking button and movable in conjunction with the locking button. The safety pin is movable between a first position and a second position along a direction different from the axial direction.

At the first position, the safety pin may interfere with the control panel in the axial direction and restrict an axial movement of the knob body toward the control panel, and at the second position, axial interference between the safety pin and the control panel may be released to allows an axial movement of the knob body toward the control panel. Therefore, only when the user presses the locking button first, the knob body may be pressed in the axial direction to operate the cooking apparatus, so the locking button may prevent arbitrary operation or errors of the knob assembly.

The knob body may include a button holder rotated relatively to the knob body. At this point, the button holder may be rotated about a rotation center concentric to the driving shaft, and may restrict movement of the locking button. As described above, the button holder rotated independently from the locking button may be provided, and operation of the locking button may be restricted depending on a position of the button holder. Therefore, the user may activate the locking button only when necessary by operating the button holder.

At the first position, the locking button may be spaced from the base portion in the axial direction at a first distance. At the second position, the locking button may be spaced from the base portion in the axial direction at a second distance. The second distance may be farther than the first distance. As described above, the locking button at the first position may interfere directly with the base portion and axial movement thereof may be restricted. Therefore, the structure for restricting the operation of the knob assembly may be simply implemented.

At the first position, a radial distance between the operating portion and the driving shaft may be farther than a radial distance between the operating portion at the second position and the driving shaft.

The locking button may be linearly moved between the first position and the second position in a direction different from the axial direction. When the direction of pressing the locking button and the direction of pressing the knob body are formed different from each other, it is less likely that the user accidentally operates the knob assembly.

The knob body may be linearly moved in a first direction that is the axial direction. The locking button may be linearly moved in a second direction perpendicular to the first direction, between the first position and the second position.

The knob body and the locking button may be restricted by each other in the axial direction, so the knob body and the locking button may be linearly moved in the axial direction.

An operating hole may be formed through the knob body in a direction perpendicular to the axial direction. The operating portion may be exposed externally through the operating hole, so the operating portion may form the external part of the knob assembly with the knob body. Then, the locking button may protrude sideways of the knob body. The locking button protruding sideways as described above may be pressed naturally by the user during the process of gripping the knob body.

The locking button may include a safety pin interfering with the base portion or released from the interference. The safety pin may protrude from the locking button in the axial direction toward the base portion.

The knob body may be linearly moved in a first direction that is the axial direction, and the locking button may be linearly moved in a second direction different from the first direction between the first position and the second position. The safety pin may protrude in the first direction.

The base portion may include a stopper interfering with the knob body. The stopper may protrude from the base portion in the axial direction toward the locking button.

The locking button may include a safety pin interfering with the base portion or released from the interference. At the first position, the stopper may be aligned with the safety pin in the axial direction and interfere with the safety pin. At the second position, the stopper may be disposed to be unaligned with the safety pin in the axial direction and thus released from the interference.

The stopper may be formed with the width gradually reduced toward the driving shaft.

The knob body may include a first knob body having an inner space that is open toward the base portion. In the inner space, a second knob body may be disposed. The second knob body may be rotated and linearly moved with the first knob body. An operating hole may be formed through the first knob body so that an operating portion of the locking button protrudes through the operating hole.

The operating hole may be open in a direction perpendicular to a linearly moving direction of the knob body.

The locking button may interfere with an edge of the operating hole when being moved from the second position to the first position, and movement thereof may be restricted.

The second knob body may include a shaft coupling portion to which an end portion of the driving shaft is coupled. A remaining portion of the second knob body, excluding the shaft coupling portion and the locking button, may be disposed opposite to each other with the shaft coupling portion as the center.

A pin block may be coupled to the second knob body. The safety pin may be provided in the pin block.

The knob body may include a pair of elastic members therein to provide an elastic force to the locking button. The second knob body may include a support plate protruding in the axial direction toward the opposite side of the base portion. The support plate may be disposed between the pair of elastic members.

The support plates may be disposed to face the operating portion.

A portion of a side surface of the second knob body, which faces the inner space, may be a curved surface. Another portion of the side surface of the second knob body, which faces the locking button, may be a flat surface.

The elastic member may provide an elastic force to the locking button in a direction of moving the locking button to the first position.

Both end portions of the elastic member may be supported by a surface of the knob body and a surface of the locking button disposed to face each other.

The locking button may include an elastic supporter by which an end portion of the elastic member is supported.

The base portion may have a base hole through which the driving shaft passes. The base portion may have a stopper protruding in the penetrating direction of the base hole. The stopper may interfere with the locking button.

The locking button may interfere with the second knob body when being moved from the first position to the second position, and movement thereof may be restricted.

A weight plate rotated and moved with the knob body may be coupled to the knob body. The weight plate may have a pin passing hole through which the safety pin of the locking button passes.

The button holder may include a button restricting position at which the button holder interferes with the locking button and movement of the locking button is restricted, and a button releasing position at which the button holder is rotated from the button restricting position and released from the interference with the locking button.

The button holder may include an interfering portion interfering with the locking button. A radial distance between the interfering portion and the locking button in the moving direction of the locking button at the button restricting position may be shorter than a radial distance between the interfering portion and the locking button in the moving direction of the locking button at the button releasing position.

The locking button may have a knob releasing position at which axial movement of the knob body is allowed. At the button restricting position, the button holder interferes with the locking button disposed at the knob releasing position, and the locking button may be restricted at the knob releasing position.

The lock button may have a knob lock position at which the lock button interferes with the control panel in the axial direction and restricts axial movement of the knob body, and a knob releasing position at which the lock button is displaced from the knob lock position in a direction different from the axial direction and allows the axial movement of the knob body. When the button holder is rotated on the rotation center concentric to the driving shaft, a radial length occupied by the button holder in the moving path may be changed.

The button holder may include a ring holder body and an interfering portion disposed in a moving path of the locking button at the button restricting position of the button holder.

The button holder may include an interfering portion protruding in the radial direction toward the rotation center of the button holder. The interfering portion may be disposed in the moving path of the locking button at the button restricting position of the button holder.

The radial protruding length of the interfering portion may be increased in the opposite direction to the direction of rotating the button holder toward the button restricting position.

At the button restricting position, the interfering portion may be disposed between the locking button and the knob body.

The interfering portion may include a position holding portion formed in the radial direction of the button holder. The locking button may include a relative holding portion in the moving direction of the locking button. At the button restricting position, position holding portion and the relative holding portion are coupled to each other so that the button holder may be held at the button restricting position.

The interfering portion may include a position holding portion formed in the radial direction of the button holder. The knob body may include a first relative holding portion facing the position holding portion. The locking button may include a second relative holding portion spaced from the first relative holding portion in the rotation path of the button holder. At the button releasing position, the position holding portion may be coupled to the first relative holding portion so that the button holder may be held at the button releasing position. At the button restricting position, the position holding portion may be coupled to the second relative holding portion so that the button holder may be held at the button restricting position.

The weight plate rotated and moved with the knob body may be coupled to the knob body. A rotation space may be formed between the weight plate and the knob body. A portion of the button holder may be disposed in the rotation space so that the button holder may be rotated along the rotation space.

The weight plate rotated and moved with the knob body may be coupled to the knob body. A central portion of the button holder may be disposed between the weight plate and the knob body in the axial direction. An edge of the button holder may be exposed toward the control panel.

A holder handle may protrude from an edge of the button holder in the axial direction toward the control panel.

The knob body may include a first knob body having a space open toward the control panel, and a second knob body rotated and linearly moved with the first knob body. The second knob body may be disposed on a position deviating from a moving path of the button holder in the inner space.

The button holder may have a first rotated state in which the interfering portion deviates from a moving path of the locking button, and a second rotated state relatively rotated from the first rotated state with respect to the knob body, and in which the interfering portion enters a moving path of the locking button.

As described above, according to the present disclosure, the knob assembly and the cooking apparatus having the same have the following effects.

In the present disclosure, when the locking button is not pressed, the knob body (handle) is not pressed in the axial direction. When the user should press the locking button first, the knob body is pressed in the axial direction so that the cooking apparatus can be operated. As described above, the locking button can prevent arbitrary operation or malfunctioning of the knob assembly, and therefore the stability of the cooking apparatus can be improved.

Furthermore, according to the present disclosure, the locking button may be operated in a direction different from the axial movement of the knob body. When the direction of pressing the locking button and the direction of pressing the knob body are formed different from each other, it is less likely that the user accidentally operates the knob assembly. Accordingly, the safety of the cooking apparatus can be increased.

Specifically, the operating portion of the locking button may be moved along a linear path or a curved path in the second direction different from the axial direction (first direction), i.e., a linearly moving direction of the knob body, and the rotation direction of the knob body. Accordingly, this further reduces the probability of the knob assembly actuated randomly due to user error or interference with objects around the cooking apparatus.

Furthermore, according to the present disclosure, the locking button may protrude sideways of the knob body. As described above, the locking button protruding sideways may be pressed naturally when the user grips the knob body. Therefore, even when the locking button is added, the ease of operation of the knob assembly is not deteriorated, and the user can easily operate the cooking apparatus.

Furthermore, according to the present disclosure, the locking button may be linearly moved between the first position at which the axial movement interferes and the second position at which the axial movement is possible. At this point, the locking button interferes with the base portion of the knob assembly or the control panel to which the knob assembly is mounted at the first position, thereby restricting movement in the axial direction. Therefore, the structure of restricting operation of the knob assembly can be simply implemented, and the number of parts added due to the locking button can be minimized.

Furthermore, according to the present disclosure, in the knob body, the second knob body (inner body) may be provided in the first knob body (outer body) forming the exterior part, and the second knob body (inner body) may be symmetric to the locking button. When the second knob body and the locking button are disposed symmetrically in the knob assembly, and it is possible to prevent the knob assembly from leaning in one direction due to a shift in its center of gravity caused by the locking button. Therefore, according to the present disclosure, the knob assembly can provide excellent operation feeling even when the locking button is added. Furthermore, in the knob assembly, the second knob body fills an empty space at one portion without the locking button, so that the durability of the entire knob assembly can be increased.

Furthermore, when the second knob body and the locking button are disposed symmetrically at the knob assembly, the volume of the parts occupied in the knob assembly can be reduced, and the inside space utilization of the knob assembly can be increased. Accordingly, the knob assembly can be miniaturized and be made light weight.

Furthermore, according to the present disclosure, the second knob body constituting the knob body may be responsible for coupling with other parts such as the driving shaft (valve shaft). Then, the first knob body exposed outward so that the user grips may have a relatively simple structure, and contraction due to a complex form thereof can be prevented during injection molding. Therefore, the aesthetic and the manufacturing quality of the knob assembly can be improved.

Furthermore, according to the present disclosure, the pair of elastic members may be provided in the knob body to return the locking button to the first position. The support plate provided in the second knob body is disposed between the pair of elastic members to guide the pair of elastic members when the elastic members are contracted/recovered. As described above, according to the present disclosure, the pair of elastic members returns the locking button with each other, so that the locking button may be stably returned without twisting to either side, which can improve the reliability of the operation of the knob assembly.

Furthermore, in the present disclosure, the button holder operated independently from the locking button is provided, and movement of the locking button can be restricted depending on the position of the button holder. For example, the button holder may hold the locking button at the knob releasing position. Then, the locking button may remain in the state that allows push movement of the knob assembly. Therefore, the user can activate the locking button by operating the button holder when necessary, which increases the convenience of the knob assembly.

Furthermore, in the present disclosure, the locking button may be moved in conjunction with the button holder during the rotating process of the button holder. When the button holder is rotated to the button restricting position, in this rotating process, the locking button may be pushed by the interfering portion of the button holder and moved naturally to the knob releasing position. Accordingly, the user can realize the released state of the knob assembly only by rotating the button holder, thereby providing the excellent operational convenience of the knob assembly.

Furthermore, in the present disclosure, the locking button is moved linearly while the button holder may be rotated. As described above, the two parts have different structures from each other, this makes it less likely that the user can accidentally activate the knob assembly. Accordingly, the cooking apparatus of the cooking apparatus can be increased.

Accordingly, in the present disclosure, the button holder may be rotated in a direction different from the moving directions of the knob body and the locking button. This can allow the moving path of the button holder and the moving path of the locking button to be set more easily in the knob assembly.

Furthermore, in the present disclosure, the button holder is disposed in the knob assembly and may not be exposed outward. To operate the button holder, the user can separate the knob assembly from the cooking apparatus first, and operate the button holder. As described above, by limiting the accessibility to the button holder, the locked state of the locking button may be prevented from being arbitrarily performed, and the operation reliability of the cooking apparatus can be improved.

In addition, when the button holder is disposed in the knob assembly and not exposed outward, it is possible to prevent the aesthetic of the knob assembly from being degraded due to exposure of the button holder.

Furthermore, when the knob assembly is separated from the cooking apparatus, the button holder may be exposed toward the user in a wide space open to the rear space of the knob assembly. Therefore, after the knob assembly is separated, the user can approach the button holder easily and operate the button holder.

Specifically, the user can grip and rotate a holder handle of the button holder, and move the button holder to the button restricting position. As described above, the user can operate easily the button holder without a separate tool, and the ease of operation of the knob assembly can be excellent.

Furthermore, in the present disclosure, the button holder may be rotated along the weight plate constituting the knob assembly. Then, without a separate part for rotation of the button holder, rotation of the button holder can be realized by using the weight plate. Therefore, even when the button holder is added, a separate part for moving the button holder is not necessary, and the knob assembly can remain in the simple structure.

Specifically, in the present disclosure, the rotation guide of the button holder is disposed in the rotation space formed between the knob body and the weight plate, and the button holder may be rotated while being held to the knob body and the weight plate in the axial direction. Therefore, the rotation of the button holder can be stable.

Furthermore, in the present disclosure, the safety pin is disposed at the locking button and may be moved with the locking button in a direction different from the moving direction of the knob body. In other words, the safety pin may be moved in a direction different from the interfering direction of the knob body and deviated from the interference position, thereby providing a released state. Therefore, a switching structure between the knob locked state and knob released state can be easily realized.

Specifically, in the present disclosure, the direction of moving the safety pin to the released state may be formed different from the moving direction (axial direction) of the knob assembly. Accordingly, even when the user presses the knob assembly with a strong force, the safety pin can remain locked solidly without moving to the releasing position. Therefore, the stability of the cooking apparatus can be improved.

Furthermore, in the present disclosure, the safety pin is provided at the locking button and may depend on movement of the locking button. Accordingly, a separate structure for relative movement between the safety pin and the locking button is not necessary, and thus the entire structure of the knob assembly can be simplified.

Furthermore, the safety pin is brought into contact with the base portion at the locking position, but the safety pin may be spaced from the base portion in the axial direction at the releasing position. Therefore, when the knob assembly is rotated at the releasing position, the safety pin remains in an uncontacted state with the base portion, which can prevent an increase in friction due to contact between the safety pin and the base portion, and the ease of operation of the knob assembly can be improved.

Furthermore, in the present disclosure, the safety pin is movable in a direction different from the interference direction, but is restricted by the movement of the locking button. Therefore, when the knob body is moved in the axial direction, the structure of the locking button and the safety pin can be moved with the knob body in the axial direction. Eventually, independent movements of the locking button and the safety pin in the axial direction toward the knob body are unnecessary, and the operational mechanism of the knob assembly can be realized more simply.

### BRIEF DESCRIPTION OF THE DRAWINGS

FIG. 1 is a perspective view showing an embodiment of a cooking apparatus to which a knob assembly according to the present disclosure is applied.

FIG. 2 is a perspective view showing a structure of a control panel and a knob assembly constituting the embodiment of the cooking apparatus shown in FIG. 1.

FIG. 3 is an exploded-perspective view showing components constituting an embodiment of the knob assembly according to the present disclosure.

FIG. 4 is an exploded-perspective view at a different angle from FIG. 3, the view showing the components constituting the embodiment of the knob assembly according to the present disclosure.

FIG. 5 is a perspective view showing a state without a first knob body and a weight plate constituting the embodiment of the knob assembly according to the present disclosure.

FIG. 6 is a perspective view showing the embodiment of the knob assembly according to the present disclosure in a first state (knob locked state).

FIG. 7 is a perspective sectional view of the embodiment of FIG. 6.

FIG. 8 is a perspective view showing the embodiment of the knob assembly according to the present disclosure in a second state (knob released state).

FIG. 9 is a perspective sectional view of the embodiment of FIG. 8.

FIG. 10 is a perspective view showing the embodiment of the knob assembly according to the present disclosure in a third state (knob pressed state).

FIG. 11 is a perspective sectional view of the embodiment of FIG. 10.

FIG. 12 is a perspective view showing the embodiment of the knob assembly according to the present disclosure in a fourth state (knob rotated state).

FIG. 13 is a perspective view showing an interference state between a base and a locking button constituting the embodiment of the knob assembly according to the present disclosure.

FIG. 14 is a perspective view showing a non-interference state between the base and the locking button constituting the embodiment of the knob assembly according to the present disclosure.

FIG. 15 is an exploded-perspective view showing components constituting a second embodiment of the knob assembly according to the present disclosure.

FIG. 16 is a perspective sectional view showing a locked state of the second embodiment of the knob assembly according to the present disclosure.

FIG. 17 is a perspective sectional view showing a released state of the second embodiment of the knob assembly according to the present disclosure.

FIG. 18 is a perspective view showing an interference state between the base and the locking button constituting the second embodiment of the knob assembly according to the present disclosure.

FIG. 19 is a perspective view showing a non-interference state between the base and the locking button constituting the second embodiment of the knob assembly according to the present disclosure.

FIG. 20 is a perspective view showing a structure of the base constituting a third embodiment of the knob assembly according to the present disclosure.

FIG. 21 is a perspective sectional view showing an inner structure of a fourth embodiment of the knob assembly according to the present disclosure.

FIG. 22 is an exploded-perspective view showing components constituting a fifth embodiment of the knob assembly according to the present disclosure.

FIG. 23 is an exploded-perspective view at a different angle from FIG. 22, the view showing the components constituting the fifth embodiment of the knob assembly according to the present disclosure.

FIG. 24 is a perspective view showing a state without a first knob body and a weight plate constituting the fifth embodiment of the knob assembly according to the present disclosure.

FIG. 25 is a perspective view showing the fifth embodiment of the knob assembly according to the present disclosure in the knob locked state.

FIG. 26 is a perspective sectional view of the embodiment of FIG. 25.

FIG. 27 is a perspective view showing the fifth embodiment of the knob assembly according to the present disclosure in the knob released state.

FIG. 28 is a perspective sectional view of the embodiment of FIG. 27.

FIG. 29 is a perspective view showing the fifth embodiment of the knob assembly according to the present disclosure in the knob pressed state.

FIG. 30 is a perspective sectional view of the embodiment of FIG. 29.

FIG. 31 is a perspective view showing the fifth embodiment of the knob assembly according to the present disclosure in the knob rotated state.

FIG. 32 is a perspective view showing a state without the first knob body constituting the fifth embodiment of the knob assembly according to the present disclosure.

FIG. 33 is a lower view showing a lower structure of the fifth embodiment of the knob assembly according to the present disclosure.

FIGS. 34 and 35 are a perspective view and a lower view showing that a locking button constituting the fifth embodiment of the present disclosure is disposed at a knob locking position and a button holder is disposed at a button releasing position.

FIGS. 36 and 37 are a perspective view and a lower view showing that the locking button constituting the fifth embodiment of the present disclosure is disposed at a knob releasing position and the button holder is disposed at the button releasing position.

FIGS. 38 and 39 are a perspective view and a lower view showing that the locking button constituting the fifth embodiment of the present disclosure is disposed at the knob releasing position and the button holder is disposed at a button restricting position.

### DETAILED DESCRIPTION OF THE DISCLOSURE

Hereinafter, exemplary embodiments of the present disclosure will be described in detail with reference to the illustrative drawings. Wherever possible, the same reference numerals will be used throughout the drawings and the description to refer to the same or like elements or parts. Furthermore, it is to be noted that, when the detailed description of the functions and configuration of conventional elements related to the present disclosure may make the gist of the present disclosure unclear, a detailed description of those elements will be omitted.

The present disclosure relates to a knob assembly 100 and a cooking apparatus having the same, and at this point, a cooktop unit 20 including a plurality of heating devices 28 may be provided at an upper portion of the cooking apparatus. The plurality of heating devices 28 may be a gas heating device 28 using gas as an energy source, an electric cooktop, or an induction. FIG. 1 illustrates the cooktop unit 20 with a gas heating device 28 among the heating devices 28 as an example. As shown in FIG. 1, the heating device 28 may be disposed to be exposed on the upper portion of the cooking apparatus. As another example, the heating device 28 may be disposed at an inner portion of the cooking apparatus or inner and outer portions of the cooking apparatus respectively.

The knob assembly 100 may be used to operate the heating device 28. A user operates the knob assembly 100 to turn on/off the heating device 28. The user operates the knob assembly 100 to adjust the amount of heat supplied by the heating device 28. Otherwise, the user manipulates the knob assembly 100 to operate an oven unit 40, 50, or select a cooking mode of the cooking apparatus.

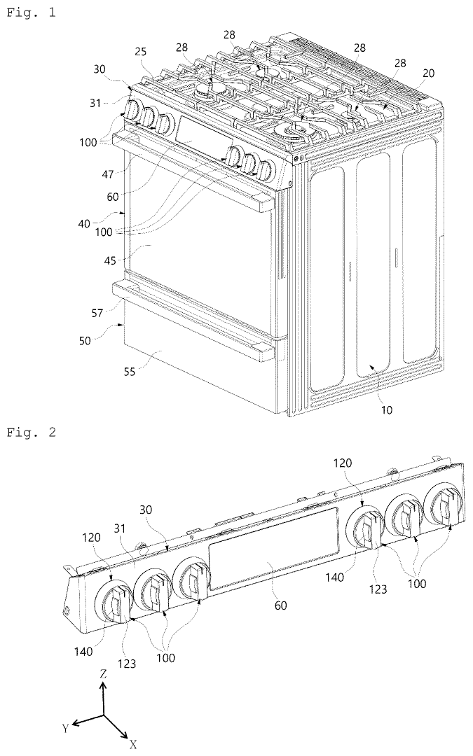

The user may press and then rotate the knob assembly 100 to control the heating device 28. At this point, as shown in FIG. 2, to prevent the knob assembly 100 from being arbitrarily operated due to user mistakes or interference with surrounding objects, the knob assembly 100 of the present disclosure includes a locking button 140. Hereinbelow, the knob assembly 100 will be described with the locking button 140 and malfunction prevention structure.

Describing a structure of the cooking apparatus, an exterior part of the cooking apparatus may be formed of an outer body 10. Without a door disposed in a front portion, the outer body 10 may form a frame of the cooking apparatus. A separate inner housing may be disposed inside the outer body 10.

At least one heating device 28 is disposed at the cooktop unit 20 to heat food to be cooked or a container in which food is stored. In the embodiment, a total of four heating devices 28 are disposed on the cooktop unit 20.

The cooktop unit 20 may include a grate 25. The grate 25 may be a frame enabling a cooking container to be placed on an upper portion of each heating device 28. The grate 25 may be removably seated on the cooktop unit 20. The grate 25 may be located above the heating devices 28.

A control panel 30 may be disposed at an upper portion of the oven unit 40, 50, and a front portion of the cooktop unit 20. The control panel 30 may include the knob assemblies 100 to operate the oven unit 40, 50 and the cooktop unit 20. A plurality of knob assemblies 100 may operate respectively the heating devices 28 and the oven devices. The control panel 30 may be a control device, or may be referred to as a front panel. The control panel 30 may not be disposed at the front portion of the cooktop unit 20, and may be disposed at different positions, such as a lower portion of the cooking apparatus, a side surface of the cooking apparatus, an upper surface of the cooking apparatus, or the like.

The control panel 30 may include a display unit 60. The display unit 60 may display information about the cooking apparatus. The display unit 60 is made of a touch panel, and may be used for the user to operate the cooking apparatus. In other words, the display unit 60 may be a type of operating portion. As another example, the display unit 60 may be omitted.

Describing the oven unit 40, 50, the oven unit 40, 50 may include a plurality of oven devices. In the embodiment, the oven unit 40, 50 may include the first oven device 40 and a second oven device 50. The first oven device 40 and the second oven device 50 may be disposed at different heights. The first oven device 40 and the second oven device 50 may have separately partitioned cooking chambers, respectively.

A first door 45 of the first oven device 40 may be operated in a type of pull-down method in which an upper end is rotated vertically on a lower end. As another example, the first door 45 may be operated in the side swing manner in which the door is opened sideways. Reference numeral 47 indicates a handle to open and close the first door 45.

A second door 55 of the second oven device 50 may be operated in a forward and backward sliding manner. As another example, like the above-described first door 45, the second door 55 may be moved in a type of pull-down method in which an upper end is rotated vertical on a lower end. Reference numeral 57 indicates a handle to open and close the second door 55.

Next, the knob assembly 100 will be described. Referring to FIGS. 1 and 2, in the embodiment, 6 knob assemblies 100 are disposed on the control panel 30. This is just one example, the control panel 30 may include 1 to 5 knob assemblies or 7 or more knob assemblies 100. As another example, the knob assembly 100 is not disposed on the control panel 30, but is disposed on an upper surface or a side surface of the cooking apparatus. As another example, the knob assembly 100 may be disposed on a lower portion of a front surface of the cooking apparatus.

As shown in FIG. 2, the knob assembly 100 may include a circular body, and a portion protruding from the circular body and facilitating the user's grip. In the embodiment, the locking button 140 is provided on a side surface of the knob assembly 100. Only when the user presses the locking button 140 first, operation of the knob assembly 100, more specifically, a movement in an axial direction is possible.

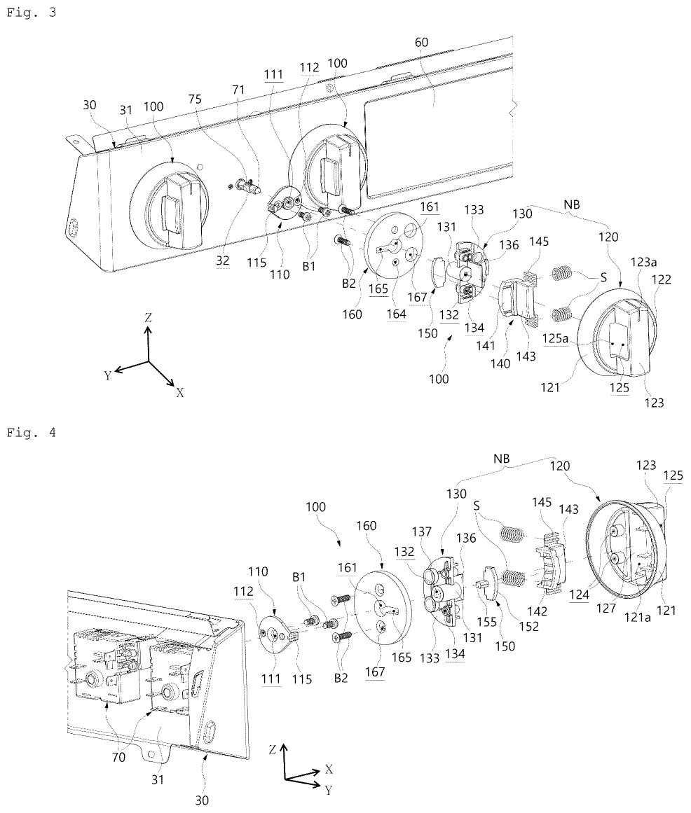

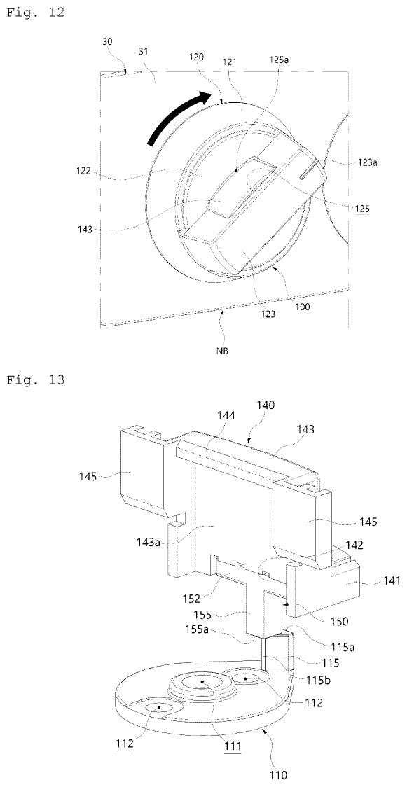

For reference, hereinbelow, the axial direction is a longitudinal direction of a driving shaft 71 (referring to FIG. 3), and is an X-axial direction in FIGS. 2 to 4. Hereinbelow, a rotation direction is a direction in which the knob assembly 100 is rotated about the driving shaft 71 (referring to arrow in FIG. 12). Furthermore, hereinbelow, a radial direction is a radial direction of the driving shaft 71 and is equal to a radial direction of a rotation path of the knob assembly 100. Hereinbelow, a linearly moving direction of the locking button 140 is a Y-axial direction in FIGS. 2 to 4. Of course, when the knob assembly 100 is rotated, the linearly moving direction of the locking button 140 may be changed.

As shown in FIGS. 3 and 4, the views shows exploded states of parts of the knob assembly 100. Describing the driving shaft 71 first for convenience of description, the driving shaft 71 will be described first. The driving shaft 71 is coupled to the knob assembly 100. The driving shaft 71 is a rotation center of the knob assembly 100. The driving shaft 71 may be rotated with the knob assembly 100 when the knob assembly 100 is rotated. The driving shaft 71 may be linearly moved with the knob assembly 100 when the knob assembly 100 is moved in the axial direction.

The driving shaft 71 may be provided at a heating driving part 70 (referring to FIG. 4). The heating driving part 70 may serve to supply an energy source to the heating device 28. For example, the heating driving part 70 may be configured to be driven by the driving shaft 71 and control the heating device 28. Therefore, the driving shaft 71 may be a valve shaft.

At this point, the energy source may be gas or electricity. When the energy source is electricity, the heating driving part 70 may be referred to as a regulator, and when the energy source is gas, the heating driving part 70 may be referred to as a valve assembly. The driving shaft 71 may be a part constituting the knob assembly 100. As another example, the driving shaft 71 may be a portion of the heating driving part 70. Reference numeral 32 indicates a through hole of a front plate 31 through which the driving shaft 71 passes.

More specifically, the driving shaft 71 may be coupled to the heating driving part 70 pushably and rotatably. At this point, when the driving shaft 71 is not pushed, the heating driving part 70 may prevent the driving shaft 71 from being rotated. As the driving shaft 71 is pushed and rotated with respect to the heating driving part 70, the heating driving part 70 may supply the energy source to the heating device 28.

The driving shaft 71 may include a coupling member 75. The coupling member 75 may surround an outer circumferential surface of the driving shaft 71. The coupling member 75 may be made of an elastic material such as a leaf spring. The coupling member 75 may be disposed between the driving shaft 71 and a shaft coupling groove 131 to be described below, and may provide an elastic force between the driving shaft 71 and the shaft coupling portion 131. Accordingly, it is possible to prevent the driving shaft 71 from being separated from the shaft coupling portion 131.

The driving shaft 71 may be operated with the knob assembly 100. More specifically, the driving shaft 71 may be coupled to a knob body NB and rotated with the knob body NB. The driving shaft 71 may be linearly moved in the axial direction with the knob body NB. Therefore, when the user manipulates the knob assembly 100, the heating driving part 70 is operated as a medium of the driving shaft 71, which allows the heating device 28 to be operated.

Describing a structure of the knob assembly 100, the knob assembly 100 may include a base portion 110. The base portion 110 may be disposed at the front plate 31 of the control panel 30. A base hole 111 is formed through the base portion 110 so that the driving shaft 71 passes therethrough, and the base hole 111 may support rotation of the driving shaft 71. In other words, the base portion 110 may allow the driving shaft 71 to be stably rotated and linearly moved in the axial direction.

As another example, the base hole 111 may be omitted in the base portion 110. In this case, the driving shaft 71 does not pass through the base portion 110 and may directly pass through the front plate 31.

The base portion 110 may have a disk structure. Around the base hole 111 formed at a central portion of the base portion 110, a base fixation hole 112 may be formed outside the base hole 111. The base fixation hole 112 is a portion through which a first fastener B1 passes, and the first fastener B1 may fasten the base portion 110 to the front plate 31.

A stopper 115 may protrude from the base portion 110. The stopper 115 protrudes in the axial direction. More specifically, the stopper 115 protrudes forward, i.e., toward the locking button 140. The stopper 115 interferes with the locking button 140 in the axial direction, restricting the locking button 140 from being moved in the axial direction. The stopper 115 may prevent the locking button 140 from being linearly moved toward the front plate 31, preventing the knob body NB also from being pressed toward the front plate 31.

When the locking button 140 is located at a first position, the stopper 115 may protrude toward the safety pin 150. When the locking button 140 is rotated with the knob body NB and disposed at a third position, the stopper 115 fixed to the control panel 30 may be spaced from the safety pin 150 in a circumferential direction. At this point, the circumferential direction is a rotation direction of the knob body NB.

The stopper 115 may be provided at an edge of the base portion 110. The stopper 115 may be provided at an end portion of the base portion 110 where the width is gradually reduced as it goes toward the end portion. The stopper 115 may be disposed farthest away from the base hole 111. The stopper 115 may have a shape in which the width is gradually reduced toward the base hole 111, i.e., as it goes toward an end portion 115b facing the driving shaft 71, and this will be described again below.

The stopper 115 may be omitted. The stopper 115 may be omitted, and the base portion 110 may have an open drive hole). A pin portion 155 of the safety pin 150, which will be described below, interferes with a surface of the base portion 110 when the locking button 140 is located at the first position, and may pass through the drive hole when the locking button 140 is located at the second position. When the pin portion 155 passes through the drive hole, the locking button 140 and the knob body NB may be moved in the axial direction.

As another example, the base portion 110 may be omitted. As another example, the base portion 110 may be integrally formed at the control panel 30. In other words, the base portion 110 may be a portion of the control panel 30. In this case, the locking button 140 and the knob body NB may interfere with the control panel 30 in the axial direction. As another example, the base portion 110 may have different polygonal shapes other than a disk shape.

A frame of the knob assembly 100 may be formed from the knob body NB. The knob body NB may surround the driving shaft 71 and the base portion 110. The knob body NB is a portion the user holds. In the embodiment, the knob body NB may include a first knob body 120 and a second knob body 130. The first knob body 120 may be exposed outward. The second knob body 130 may be disposed inside the first knob body 120.

In the embodiment, the first knob body 120 may be exposed outward and be a portion by which the user operates the knob assembly 100. The second knob body 130 may be disposed inside the first knob body 120, and be responsible for the connection to other parts, and guide an elastic member S to be described below. As another example, the first knob body 120 and the second knob body 130 may be integrally formed with each other.

The first knob body 120 may include a knob ring 121 having a conical or cylindrical shape. The knob ring 121 is disposed to face the front plate 31. A grippable part 123 may protrude from an upper surface 122 of the knob ring 121. The grippable part 123 protrudes from the upper surface 122 of the knob ring 121 in the axial direction. The grippable part 123 may be a portion where the user grips. The grippable part 123 may extend lengthily in a direction perpendicular to the axial direction (referring to Z-axial direction in FIG. 2). Reference numeral 123a is a reference marking formed in the grippable part 123. A marking may also be marked on a surface of the knob ring 121.

An operating hole 125 may be formed through the knob body NB in the direction perpendicular to the axial direction. The operating portion 143 of the locking button 140 is exposed outward through the operating hole 125, and may form the exterior part of the knob assembly 100 with the knob body NB. As shown in FIG. 2, the operating portion 143 that is a portion of the locking button 140 protrudes from the knob body NB, and may form the exterior part of the knob assembly 100 with the knob body NB. In other words, a portion of the locking button 140 may be said to fill the operating hole 125.

In the embodiment, the operating hole 125 where the operating portion 143 of the locking button 140 protrudes may be formed through the first knob body 120. More specifically, the operating hole 125 is formed through the grippable part 123 of the first knob body 120. At this point, since the operating hole 125 is formed in the direction perpendicular to the axial direction, the operating portion 143 of the locking button 140 may also protrude through the operating hole 125 in the direction perpendicular to the axial direction. In other words, the operating hole 125 may be open in the direction perpendicular to the linearly moving direction of the knob body NB.

The operating hole 125 may be formed one of left and right surfaces of the first knob body 120. In the embodiment, the operating hole 125 may be formed on the left surface of the first knob body 120. In the embodiment, the knob assembly includes only one locking button 140, and the operating hole 125 only needs to be formed on one surface of the first knob body 120. As another example, the operating hole 125 may be formed on the right surface of the first knob body 120. As another example, the operating hole 125 may be formed each of the right and left surfaces of the first knob body 120.

As described below, the locking button 140 may be restricted from being moved because it interferes with an edge 125a of the operating hole 125 in a process of moving the locking button from the second position to the first position. The locking button 140 is caught by the edge 125a of the operating hole 125, which allows the locking button 140 to stay at an inner space 121a formed in the first knob body 120 without being completely separated from the knob body NB. The edge 125a of the operating hole 125 may be a holding end 125a. The first position and the second position of the locking button 140 will be described in detail below.

The second knob body 130 may be disposed at the inner space 121a of the first knob body 120. The second knob body 130 may be coupled to the first knob body 120 with a second fastener B2. The second fastener B2 passes through a weight plate 160 and the second knob body 130 successively, and then may be fixed to an assembly hole 124 of the first knob body 120. Accordingly, the first knob body 120, the second knob body 130, and the weight plate 160 may be assembled with each other and operated together.

The second knob body 130 may include a shaft coupling portion 131 to which an end portion of the driving shaft 71 is coupled. The shaft coupling portion 131 may have a cylindrical shape. The shaft coupling portion 131 may be disposed at a center portion of the knob body NB. The shaft coupling portion 131 includes a shaft coupling hole 132, and the driving shaft 71 may be inserted into the shaft coupling hole 132. The driving shaft 71 may be fixed in the shaft coupling hole 132 without spinning with no traction in the shaft coupling hole 132.

When an end portion of the driving shaft 71 is inserted into the shaft coupling hole 132, the driving shaft 71 may be rotated with the second knob body 130, and moved with the second knob body 130 in the axial direction. In other words, when the second knob body 130 is driven with the first knob body 120, the driving shaft 71 may be driven. For example, when the second knob body 130 is pushed with the first knob body 120 in the axial direction, the driving shaft 71 is also moved in the axial direction. When the second knob body 130 is rotated about the driving shaft 71 with the first knob body 120, the driving shaft 71 is also rotated with the knob bodies. Therefore, the driving shaft 71 may be a rotation shaft.

The second knob body 130 may be coupled to the driving shaft 71 and coupled to the weight plate 160. As described above, the second knob body 130 is implemented with the coupling structure with other parts, which forms the first knob body 120 to have a relatively simple thin structure. Therefore, when the first knob body 120 is formed in the injection molding, it is possible to prevent phenomenon of sink mark or flow mark from occurring as a portion of the first knob body 120 is contracted due to a complex form.

The second knob body 130 may include a body plate 133. The body plate 133 may have a plate structure. The shaft coupling portion 131 is connected to the body plate 133. The body plate 133 is a portion coupled to the first knob body 120 and the weight plate 160. To this end, the body plate 133 includes a fastener passing hole 134 formed therethrough, and the second fastener B2 passes through the fastener passing hole 134. Referring to FIG. 4, a plate protrusion 137 is provided on the body plate 133, and the plate protrusion 137 is inserted into a plate groove 167 (referring to FIG. 3) of the weight plate 160. As another example, the second knob body 130 and the first knob body 120 may be forcibly inserted to each other or fixed to each other with an adhesive.

In the embodiment, the body plate 133 may have a semicircular form to correspond to the form of the inner space 121a. In other words, a portion of a side surface of the second knob body 130 facing an inner surface of the inner space 121a has a curved surface form, and the other portion of the side surface of the second knob body 130 facing the locking button 140 may have a flat surface form. The portion having a curved surface form faces an inner surface of the inner space 121a, and the portion having a flat surface form faces the locking button 140. A portion of the locking button 140 may interfere with the flat surface portion of the second knob body 130. The locking button 140 interferes with the flat surface portion of the second knob body 130, so that a moving distance from the first position to the second position may be restricted.

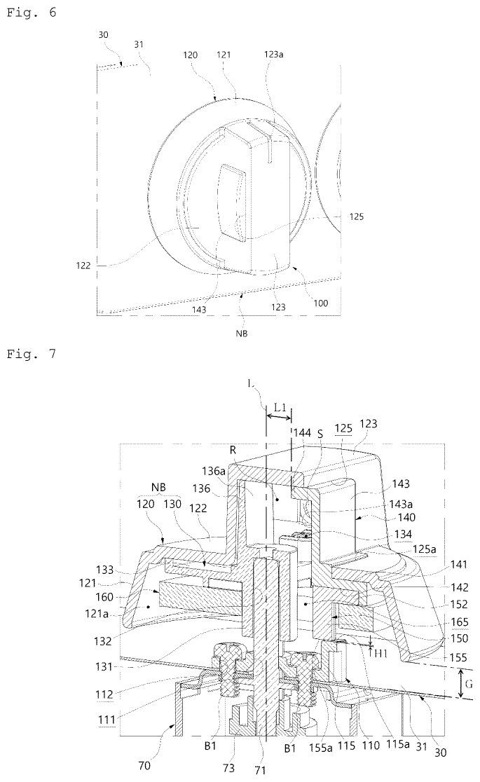

The second knob body 130 may include a support plate 136. The support plate 136 may protrude in the axial direction toward the opposite side of the base portion 110. The support plate 136 may protrude from the body plate 133 into a plate form. The support plate 136 may extend in the same direction as the grippable part 123, i.e., in the direction perpendicular to the axial direction. An end portion of the support plate 136 may be brought into close contact with the inner surface of the first knob body 120, i.e., with an inner surface of the grippable part 123. This state is shown in FIG. 7.

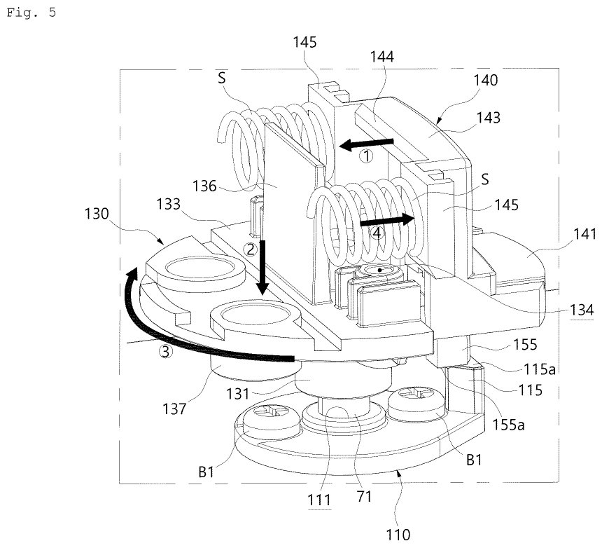

The support plate 136 may be disposed between a pair of elastic members S, which will be described below. As shown in FIG. 5, the support plate 136 is disposed between the pair of elastic members S, and may maintain an interval between the pair of elastic members S. In other words, the support plate 136 may prevent the pair of elastic members S from being twisted in either direction in a contracting/recovery process.

A remaining portion of the second knob body 130 without the shaft coupling portion 131, and the locking button 140 may be disposed opposite each other with the shaft coupling portion 131 as the center. More specifically, the body plate 133 and the locking button 140 may be disposed opposite each other with the driving shaft 71 as the center. As shown in FIG. 7, based on the driving shaft 71, the body plate 133 is disposed at the left part, and the locking button 140 is disposed at the right part. Thereafter, this prevents the knob assembly 100 from leaning in one direction due to a shift in its center of gravity caused by the locking button 140. Furthermore, in the inner space 121a, the body plate 133 fills an empty space at one portion without the locking button 140, which can improve the durability of the entire knob assembly 100.

As shown in FIGS. 3 and 4, the knob assembly 100 includes the locking button 140. The locking button 140 is disposed at the knob body NB and may be dependent on a movement of the knob body NB. Fundamentally, when the knob body NB is linearly moved in the axial direction or rotated about the driving shaft 71, the locking button 140 may be linearly moved or rotated with the knob body NB. However, the locking button 140 may be moved in a direction different from the axial direction, independently from the knob body NB.

The locking button 140 may form a portion of a grippable surface that the user grips when the user grips the knob assembly 100. For example, when the user grips the knob assembly 100 with a thumb and a fore finger, the fore finger grips the surface of the grippable part 123 and simultaneously the thumb grips the operating portion 143 of the locking button 140. In this state, when the user presses the knob assembly 100 with the thumb and the fore finger, although the surface of the grippable part 123 is held, the operating portion 143 located opposite thereto is pressed and moved into the knob body NB.

As shown in FIG. 5, the locking button 140 may be disposed, based on the shaft coupling portion 131, opposite to a remaining portion excluding the shaft coupling portion 131 from the second knob body 130. More specifically, the body plate 133 and the locking button 140 may be disposed opposite each other with the driving shaft 71 as the center.

The locking button 140 may restrict the knob body NB, the weight plate 160, and the locking button 140 constituting the knob assembly 100 from being moved in the axial direction, i.e., toward the control panel 30, or release restriction of movement. The locking button 140 may include a first position at which the locking button interferes with the base portion 110 to restrict movement in the axial direction, and a second position at which the locking button is enabled to be moved in the axial direction. Therefore, the first position may be a knob locking position, and the second position may be a knob releasing position.

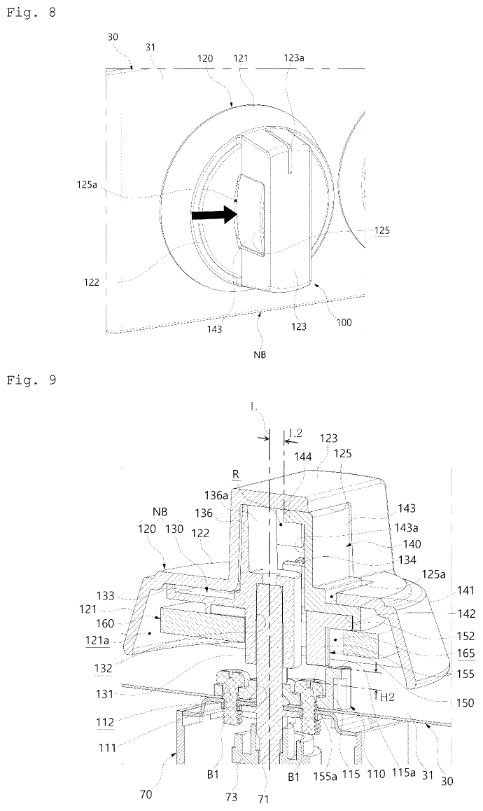

At this point, the first position is a state in which the locking button 140 protrudes relatively from the knob body NB, and is a state shown in FIGS. 6 and 7. At the first position, the locking button 140 is disposed at the farthest position from the driving shaft 71 in the radial direction. At the same time, the first position is a position at which a safety pin 150 is located at the farthest position from the driving shaft 71 in the radial direction. The second position is a position where the locking button 140 is moved when being pressed from the first position, and is the state shown in FIGS. 8 and 9. At the second position, the locking button 140 is disposed closest to the driving shaft 71 in the radial direction. At the same time, the second position is a position where the safety pin 150 is disposed closest to the driving shaft 71 in the radial direction.

At the first position, the locking button 140 may interfere with the base portion 110 in the axial direction. At this point, interference means restriction to an axial movement of the locking button 140. As described above, when the locking button 140 interferes with the base portion 110 in the axial direction, the interference may prevent the locking button 140 from being moved in the axial direction toward the control panel 30, or restrict a moving distance of the locking button 140.

The knob body NB and the locking button 140 interfere with each other in the axial direction, and thus the knob body NB and the locking button 140 may be linearly moved together in the axial direction. Since the locking button 140 and the knob body NB are restricted by each other in the axial direction, when the axial movement of the locking button 140 is restricted, an axial movement of the entire knob body NB is also restricted.

At this point, the locking button 140 may be linearly moved between the first position and the second position in a direction different from the axial direction. In the embodiment, the locking button 140 may reciprocate between the first position and the second position while being moved in a direction perpendicular to the axial direction. As another example, the locking button 140 may be moved in an oblique direction while having a predetermined angle with respect to the axial direction. As another example, the locking button 140 may be moved while having a curved path with respect to the axial direction.

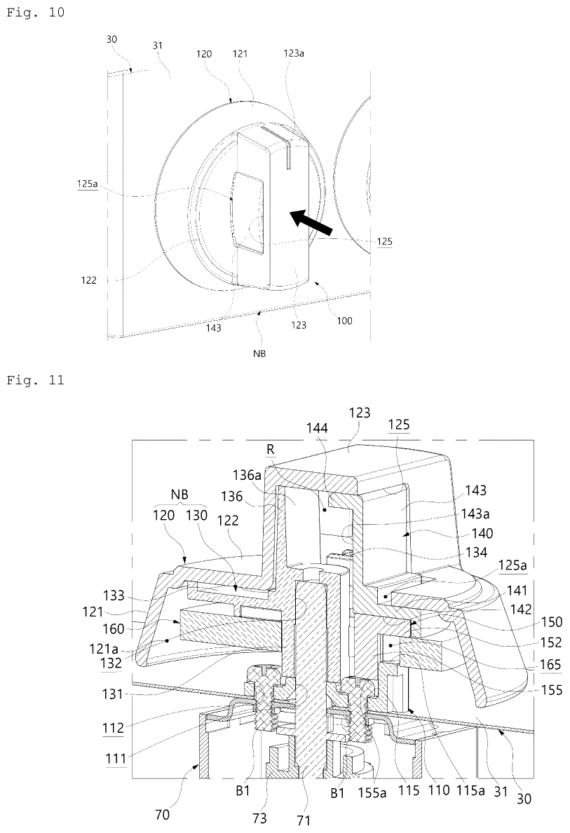

FIGS. 7 and 8 are views showing the locking button 140 located at the first position. FIGS. 9 and 10 are views showing the locking button 140 located at the second position. In other words, when the locking button 140 at the first position is pressed, the locking button 140 may be moved to the second position. The locking button 140 at the second position may be returned to the first position again when an external force pressing the locking button 140 is removed.

As shown in FIG. 7, at the first position, the locking button 140 and the base portion 110 may be spaced from each other in the axial direction at a first distance H1. In the embodiment, at the first position, the pin portion 155 and the base portion 110 are spaced from each other at the first distance H1. As shown in FIG. 9, at the second position, the locking button 140 and the base portion 110 may be spaced from each other in the axial direction at a second distance H2. In the embodiment, at the second position, the pin portion 155 and the base portion 110 are spaced from each other at the second distance H2. The second distance H2 may be formed farther than the first distance H1. For reference, in FIG. 7, the first distance H1 indicates a distance between a surface 155a of the pin portion 155 and a surface 115a of the stopper 115 provided at the base portion 110. In FIG. 9, the second distance H2 indicates a distance between the surface 155a of the pin portion 155 and a first fastener B1 fixing the base portion.

As described above, at the second position, the locking button 140 and the base portion 110 are spaced from each other at the second distance H2, and the second distance H2 means a distance of moving the locking button 140 in the axial direction. Since the locking button 140 is linearly moved with the knob body NB in the axial direction, the second distance H2 is a distance the knob body NB is movable in the axial direction. In FIG. 7, the reference numeral G indicates a distance between the knob body NB and the front plate 31. When the locking button 140 is disposed at the second position, the knob body NB and the locking button 140 may be moved together in a direction of reducing the gap G.

The first distance H1 may be 0. When the first distance H1 is 0, at the first position, a surface of the locking button 140, more specifically, the surface 155a of the pin portion 155 and the surface 115a of the stopper 115 may be brought into close contact with each other. Therefore, at the first position, the locking button 140 cannot be completely moved in the axial direction. As another example, the first distance H1 may be greater than 0.

The first distance H1 is shorter than a distance in which the knob assembly 100 can presses the driving shaft 71 to activate operation of the cooking apparatus. In other words, the first distance H1 is shorter than the minimum distance (reference distance) in which the driving shaft 71 should be moved in the axial direction in order to activate the cooking apparatus. Therefore, even when the first distance H1 is greater than 0, the axial moving distance of the knob assembly 100 is shorter than the reference distance of the driving shaft 71, and this does not lead to rotation of the driving shaft 71.

A radial distance L1 between the operating portion 143 at the first position and the driving shaft 71 may be farther than the radial distance L2 between the operating portion 143 and the driving shaft 71 at the second position. In other words, when the locking button 140 is moved to the second position, the radial distance between the locking button 140 and the driving shaft 71 is shortened. At this point, the radial distance is a direction from the driving shaft 71 toward an edge of the knob body NB.

As shown in FIG. 7, the radial distance L1 between the operating portion 143 at the first position and the driving shaft 71 may be a distance between a protruding end 144 protruding from the operating portion 143 of the locking button 140 and a central line L extending from the driving shaft 71. Likewise, as shown in FIG. 9, the radial distance L2 between the operating portion 143 and the driving shaft 71 at the second position may be a distance between a protruding end 144 protruding from the operating portion 143 of the locking button 140 and a central line L extending from the driving shaft 71.

Describing a structure of the locking button 140 with reference to FIG. 5, the locking button 140 may include a button body 141. The button body 141 may be inserted into the inner space 121a. The button body 141 may extend in a direction perpendicular to the axial direction. A side surface of the button body 141 may have a form of curved surface to correspond to the inner surface of the inner space 121a.

Referring to FIG. 7, the button body 141 may include a pin coupling part 142 at a lower portion. The pin coupling part 142 is a portion to which the safety pin 150 is connected. The safety pin 150 may be connected to the pin coupling part 142. The pin block 152 provided in the safety pin 150 may be coupled to the pin coupling part 142 in a sliding manner in the direction perpendicular to the axial direction. As another example, the pin block 152 of the safety pin 150 may be bonded to the pin coupling part 142. As another example, the pin block 152 of the safety pin 150 may be screw-fastened to the pin coupling part 142.

The button body 141 may include the operating portion 143. The operating portion 143 may extend in a direction of standing the operating portion on the button body 141. At this point, the standing direction is a vertical direction based on FIG. 5. The operating portion 143 may be a portion that the user pushes to manipulate the button body 141. The grippable surface may be formed by at least a part of the operating portion 143 exposed through the operating hole 125 outward of the knob assembly 100.

Referring to FIG. 7, the surface 143a of the operating portion 143 and the surface 136a of the support plate 136 of the second knob body 130 may be disposed to face each other. A predetermined empty space R is formed between the surface 143a of the operating portion 143 and the surface 136a of the support plate 136, and the empty space is an available space to enable the operating portion 143 of the locking button 140 to be moved.

The operating portion 143 may include a protrusion end 144. The protrusion end 144 may extend from the operating portion 143 in the direction perpendicular to the direction in which the operating portion 143 extends from the button body 141. The protrusion end 144 may expand a contact area between the surface of the operating portion 143 and the surface of the knob body NB. As shown in FIG. 7, an upper surface of the protrusion end 144 and a lower surface of the first knob body 120 forming the knob body NB are in contact with each other. The protrusion end 144 enables the locking button 140 to be moved stably in a constant direction (left-right direction based on FIG. 7).

As shown in FIG. 5, the operating portion 143 may include an elastic supporter 145. The elastic supporter 145 supports an end portion of the elastic member S. The elastic supporter 145 is provided at each side of the operating portion 143, supporting the end portion of the elastic member S. The elastic supporter 145 may protrude more toward the center of the inner space 121a than the operating portion 143. A surface of the elastic supporter 145 may have a flat surface structure.

In the embodiment, the pair of elastic supporters 145 is disposed more outward than the support plate 136 of the second knob body 130. The elastic member S is disposed on each side of the support plate 136, and the pair of elastic members S may be respectively supported by the pair of elastic supporters 145. Accordingly, when the ends of the pair of elastic members S1 are supported by the pair of elastic supporters 145, and the support plate 136 may maintain an interval between the pair of elastic members S.

The elastic members S may provide elasticity to the locking button 140 in a direction of moving the locking button 140 to the first position. In the embodiment, the elastic member S are disposed at the opposite sides of the support plate 136. The pair of elastic members S enables the locking button 140 to reciprocate in a constant direction without leaning or twisting in one direction.

The opposite end portions of each elastic member S may be supported by the surface of the knob body NB and the surface of the locking button 140 disposed to face each other. More specifically, first end portions of the elastic members S are supported by the elastic supporters 145, and second end portions of the elastic members S may be supported by an inner wall 127 (referring to FIG. 4) of the first knob body 120.

As show in FIGS. 5 and 7, the knob body NB may include the safety pin 150 interfering with the base portion 110 or released from the interference. The safety pin 150 may protrude more than the locking button 140 in the axial direction toward the base portion 110. The pin portion 155 of the safety pin 150 may be a cantilever structure. At the first position, the pin portion 155 may be a portion substantially interfering with the base portion 110.

The knob body NB may be linearly moved in the first direction that is the axial direction, and the safety pin 150 may be linearly moved between the first position and the second position in the second direction different from the first direction. At this point, the safety pin 150 may be operated in conjunction with the locking button 140 and moved along the locking button 140. The pin portion 155 of the safety pin 150 protrudes in the first direction, and the pin portion 155 protruding may be linearly moved by the locking button 140 between the first position and the second position.

The safety pin 150 may interfere with the stopper 115 of the base portion 110. At the first position, the stopper 115 is aligned with the safety pin 150 in the axial direction and interferes with the safety pin 150. At the second position, the stopper 115 is disposed to be unaligned with the safety pin 150 in the axial direction, removing interference. As described above, depending on the position of the locking button 140, the safety pin 150 may interfere with the stopper 115 or be released from interference with the stopper 115. This structure will be described below.

The safety pin 150 may include the pin block 152. The pin block 152 is a portion coupled to the pin coupling part 142 and has a plate structure. The pin portion 155 of the safety pin 150 protrudes from the pin block 152 in the axial direction. The pin block 152 may be made of a material different from the operating portion 143 of the locking button 140. For example, the safety pin 150 where an external force is concentrated when the user presses the knob assembly 100 in the axial direction may be made of a metal material having relatively excellent durability. As another example, the pin block 152 is omitted, and the pin portion 155 may be coupled directly to the pin coupling part 142.

The safety pin 150 may be connected to the pin coupling part 142 of the locking button 140 through the pin block 152. The safety pin 150 connected to the pin coupling part 142 may be dependent on the movement of the locking button 140. In other words, the safety pin 150 may be moved with the locking button 140 in the axial direction and rotated about the driving shaft 71.

As another example, the safety pin 150 is omitted, a protrusion may be provided directly on the locking button 140. A portion of the locking button 140 may protrude in the first direction i.e., the axial direction, to form the protrusion. As another example, the locking button 140 may be a portion of the safety pin 150. As another example, the locking button 140 is omitted, and the safety pin 150 may be connected directly to the knob body NB. When the locking button 140 is omitted, the safety pin 150 may be operated by the user.

As another example, the knob body NB may include multiple safety pins. The multiple safety pins may interfere with multiple stoppers 115 or a surface of the base portion 110.

Describing operations of the knob body NB and the locking button 140 with reference to FIG. 5, the locking button 140 may be pressed in the direction of the arrow \textcircled{1}. When the locking button 140 is pressed in the direction of the arrow \textcircled{1}, the locking button 140 is displaced from the first position to the second position. For reference, In FIG. 5, the locking button 140 is disposed at the first position so that the movement thereof in the axial direction is restricted. When the locking button 140 is moved in the direction of the arrow \textcircled{1}, excluding the base portion 110, the knob assembly 100 including the second knob body 130 may be moved in the axial direction (direction of arrow \textcircled{2}).

The knob assembly 100 moved in the axial direction as described above may be rotated in the direction of the arrow \textcircled{3}. At this point, with the second knob body 130, the first knob body 120 and the locking button 140 may also be rotated. The second knob body 130 may be rotated in a direction opposite to the direction of the arrow \textcircled{3}. Meanwhile, when the user removes the force of pressing the locking button 140, the locking button 140 may be moved in the direction of the arrow \textcircled{4} and returned to the first position by the elastic member S.

Referring to FIGS. 3 and 4, the weight plate 160 may be coupled to the knob body NB, and rotated and moved with the knob body NB. The weight plate 160 may have a disk structure to correspond to the inner space 121a. The weight plate 160 increases the total weight of the knob assembly 100, thereby providing great operation feeling of the knob assembly 100. To this end, the weight plate 160 may be made of a metal material.

A shaft passing hole 161 may be formed through a central portion of the weight plate 160, and the driving shaft 71 may be inserted into the shaft passing hole 161. A plate fastening hole 164 through which the second fastener B2 passes and the plate groove 167 may be formed around the shaft passing hole 161. The plate groove 167 is fitted over the plate protrusion 137 of the body plate 133.

The weight plate 160 may have the pin passing hole 165 formed therethrough. The plate fastening hole 164 may be a portion through which the door fastener B2 passes. At this point, the pin portion 155 should be displaced from the first position to the second position, so the pin passing hole 165 may extend in the radial direction of the weight plate 160. The pin portion 155 may be displaced from the first position to the second position while inserted in the pin passing hole 165.

FIGS. 6 to 12 show the operation of the parts constituting the embodiment successively. First, as shown in FIGS. 6 and 7, the views show the locking button 140 located at the first position. When the locking button 140 is located at the first position, the operating portion 143 protrudes outward of the operating hole 125. When the locking button 140 is located at the first position, the safety pin 150 is aligned with the stopper 115 of the base portion 110 in the axial direction, thereby restricting the safety pin 150 from being moved in the axial direction. In FIG. 7, the first distance H1 between the pin portion 155 of the safety pin 150 and the stopper 115 is shorter than a distance in which the knob assembly 100 presses the driving shaft 71 and activates operation of the cooking apparatus.

In this state, when the user presses the operating portion 143 in the direction of the arrow in FIG. 8, the locking button 140 may be inserted into the knob body NB. At this point, the user should press the operating portion 143 while overcoming the elastic force of the elastic member S. Then, the locking button 140 may be moved to the second position. As described above, the locking button 140 protruding sideways may be pressed naturally when the user grips the knob body NB. Therefore, even when the locking button 140 is added, the ease of assembly of the knob assembly 100 is not deteriorated, and the user can operate the cooking apparatus easily.

As shown in FIG. 9, the safety pin 150 is not aligned with the stopper 115 of the base portion 110 in the axial direction, and is disposed at a position deviating from the stopper 115. At this point, the deviant position is that the pin portion 155 of the safety pin 150 and the stopper 115 are not disposed to face each other in the axial direction. Therefore, the safety pin 150 may be moved in the axial direction without interference with the stopper 115. In FIG. 9, H2 indicates a movable distance of the safety pin 150.

The user can grip the grippable part 123 and press the knob body NB in the axial direction, while pressing the locking button 140. In FIG. 10, the arrow indicates a direction of the knob body NB pressed in the axial direction. Then, the knob body NB, the locking button 140, and the weight plate 160 may be moved in the front plate 31 at the same time.

As described above, in the embodiment, the locking button 140 may be operated in the different direction from the axial movement of the knob body NB. When the direction of pressing the locking button 140 and the direction of pressing the knob body NB are formed different, it is less likely that the user accidentally operates the knob assembly 100.

More specifically, the operating portion 143 of the locking button 140 may be linearly moved in the second direction (leftward-rightward direction in FIG. 9) different from the axial direction (first direction, vertical direction in FIG. 10), i.e., the linearly moving direction of the knob body NB, and the rotation direction of the knob body NB. Accordingly, this further reduces the probability of the knob assembly 100 actuated randomly due to user error or interference with objects around the cooking apparatus.

As shown in FIG. 11, compared to FIG. 9, the view shows the knob body NB, the safety pin 150, and the weight plate 160 moved closer to the control panel 30. The safety pin 150 may pass through the stopper 115 and be moved closer to the base portion 110. In the embodiment, an end portion of the safety pin 150, i.e., the pin portion 155 may be moved to a position in contact with the first fastener B1.

When the knob body NB, the locking button 140, and the weight plate 160 are moved in the axial direction, the second knob body 130 fixing the driving shaft 71 through the shaft coupling portion 131 may move the driving shaft 71 together in the axial direction. The driving shaft 71 moved in the axial direction may drive the heat driving part 70 of the cooking apparatus. At this point, driving of the heating driving part 70 includes various types of operations such as on/off of the cooking apparatus, cooking mode selection of the cooking apparatus, and the like.

When the driving shaft 71 is moved in the axial direction at a reference distance, the driving shaft 71 may be rotated. In the embodiment, the heating driving part 70 restricts that the driving shaft 71 should be moved at the reference distance in the axial direction to be rotated. FIG. 12 illustrates the knob body NB rotated clockwise, and the driving shaft 71 may also be rotated clockwise with the knob body NB. As described above, when the knob body NB is rotated, the locking button 140 may be moved to the third position. At this point, when the driving shaft 71 is rotated together by the knob body NB, it is possible to implement functions such as fire control of the cooking apparatus, the number of activated heating devices 28, selection of cooking modes, and the like.

As described above, in the embodiment, the operation of the locking button 140 precedes the operation of the knob body NB. The knob body NB can be rotated and linearly moved only when the locking button 140 is moved in the second position, and in this process, the driving shaft 71, which is dependent on the knob body NB, may be operated together.

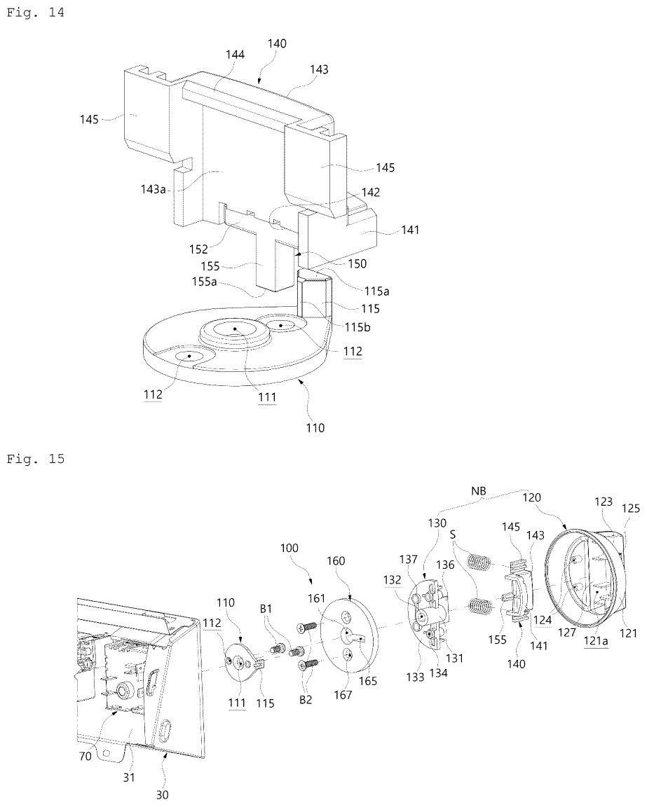

Describing in detail a structure and operation of the locking button 140, FIGS. 13 and 14 show relative position of the locking button 140 and the base portion 110 shown in FIGS. 9 and 11, in detail. As shown in FIG. 13, at the first position, the surface 155a of the pin portion 155 faces a surface 115a of the stopper 115. The surface 155a of the pin portion 155 overlaps with the surface 115a of the stopper 115 in the axial direction, and thus the safety pin 150 may be supported by the stopper 115.

At this point, the stopper 115 may be formed so that the width of an end portion toward the driving shaft 71 is gradually reduced. At this point, the direction toward the driving shaft 71 is a direction toward the base hole 111 of the base portion 110 based on FIG. 13. As described above, the stopper 115 is formed so that the width thereof is reduced toward the end portion, thereby forming a guide surface 115b. The guide surface 115b may prevent interference between the stopper 115 and the safety pin 150 when the knob assembly 100 is returned from the third position to the first position.

More specifically, in the process in which the knob assembly 100 pressed in the axial direction is rotated in the opposite direction to the axial direction and then returned to the original state, the safety pin 150 may be brought into contact with the stopper 115. When the pin portion 155 of the safety pin 150 is brought into contact with the stopper 115, the pin portion 155 may be guided by the guide surface 115b, and the entire locking button 140 may be moved to the second position. In other words, when the knob assembly 100 is returned to the original state, the pin portion 155 may be moved on the guide surface 115b of the stopper 115 and returned to the original state, without being not rotated due to catching by the stopper 115.

Meanwhile, when a cross-sectional area of the stopper 115 is narrowed in the driving shaft 71, as the knob assembly goes from the first position to the second position, an area where the surface 155a of the pin portion 155 and the surface 115a of the stopper 115 over with each other in the axial direction may be significantly reduced. Accordingly, even when manufacturing tolerances occur, the locking button 140 may be movable at the second position, and the axial movement may be stably restricted at the first position.

As shown in FIG. 14, at the second position, the safety pin 150 is completely separated from the stopper 115. When the pin portion 155 of the safety pin 150 is separated from the stopper 115, the safety pin 150 is movable in the axial direction. As described above, in the embodiment, the locking button may be linearly moved between the first position at which the axial movement interferes and the second position at which the axial movement is possible. At this point, the locking button 140 interferes directly with the base portion 110 of the knob assembly 100 at the first position so that the axial movement is restricted. Therefore, the structure restricting the operation of the knob assembly 100 can be simply implemented.

In FIG. 15, the view shows an exploded state of the components constituting the second embodiment of the knob assembly 100 according to the present disclosure. Describing only a structure different from the preceding embodiments, the locking button 140 includes the safety pin 150 integrally formed. The safety pin 150 protrudes from the surface of the locking button 140 toward the base portion 110.

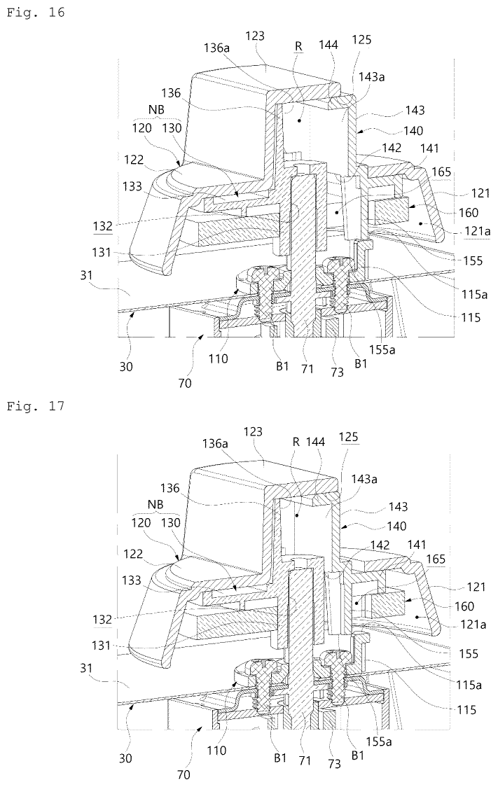

The safety pin 150 may protrude from an edge of the locking button 140. At this point, the edge of the locking button 140 is a portion of the surface 155a (Referring to FIG. 16) of the safety pin 150 toward the central portion of the driving shaft 71.

FIGS. 16 and 17 show the second embodiment of the knob assembly 100 according to the present disclosure in a knob locked state and a knob released state, respectively. As shown in the drawings, the safety pin 150 may protrude downward from a lower surface of the locking button 140. The pin portion 155 of the safety pin 150 is provided integrally with the locking button 140, and may be moved with the safety pin 150 between the first position (shown in FIG. 16) and the second position (shown in FIG. 17).

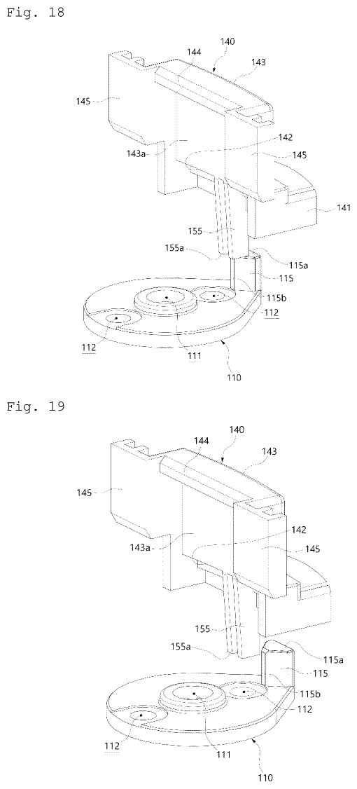

FIGS. 18 and 19 show only the base portion 110 and the locking button 140 constituting the second embodiment of the knob assembly 100 according to the present disclosure. In FIG. 18 showing the locking button 140 interfering with the stopper 115 of the base portion 110, the safety pin 150 is disposed to overlap with an upper portion of the stopper 115 in the axial direction.

At this point, the pin portion 155 of the safety pin 150 has a pair of plates, and the pair of plates are spaced from each other. As described above, the durability of the pin portion 155 having a pair of plates may be improved. Therefore, even when a large external force is applied to press the knob body NB in the axial direction with the safety pin 150 not pressed, the pin portion 155 can resist the external force. FIG. 19 shows the pin portion 155 with the structure of the pair of plates, which deviates completely from the stopper 115.

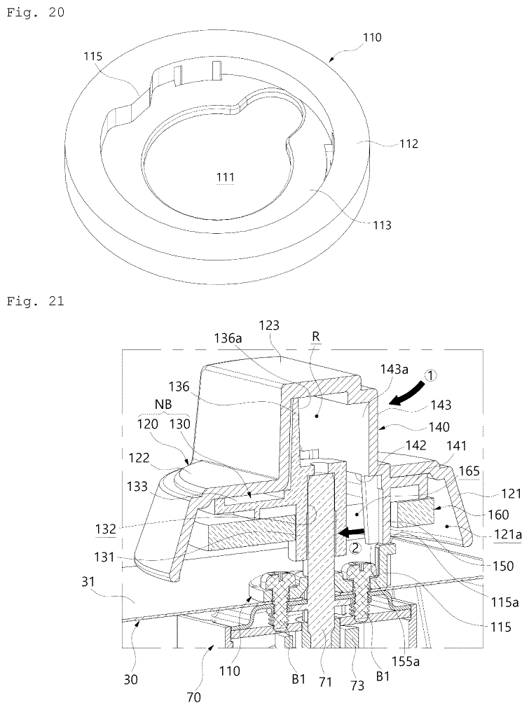

FIG. 20 shows the base portion constituting the third embodiment of the knob assembly according to the present disclosure. Describing a structure different from the preceding embodiments, the base portion 110 may include the base hole 111 formed through a central portion thereof. The base body 112 having a ring shape may be provided around the base hole 111. When the base portion 110 is disposed on a front surface of the control panel 30, the base body 112 may protrude from a front surface of the control panel 30. The base body 112 may include a curved inner circumferential surface. The safety pin 150 may be rotated along the inner circumferential surface.

The base portion 110 may include a base plate 113. The base plate 113 may form a bottom plate of the base portion 110. The base hole 111 is formed through a central portion of the base plate 113. The base plate 113 may be formed in a thin plate structure. The pin portion 155 of the safety pin 150 may be rotated while facing the base plate 113 after being moved to the second position.

At this point, the stopper 115 may be formed in the base body 112. A portion of the base body 112 may protrude toward a central portion of the base portion 110 to form the stopper 115. In other words, the stopper 115 may protrude from a central portion of a rotation path of the safety pin 150 in a radial direction of the rotation path. Since the safety pin 150 is inserted into the stopper 115 and interferes, the stopper 115 may be referred to as an interfering portion. As another example, the stopper 115 does not further protrude in the radial direction of the rotation path, and may have only a structure stepped from the base plate 113 in the axial direction. As described above, in the embodiment, the stopper 115 may have the structure not protruding in the axial direction.

When the safety pin 150 is disposed at the first position, the pin portion 155 is disposed at an upper portion of the stopper 115. Accordingly, the pin portion 155 interferes with the stopper 115 not to move in the axial direction or to move by a limited distance. Therefore, the safety pin 150 and the knob body NB restricted by the safety pin 150 may also not be moved in the axial direction or be moved by a limited distance.

When the safety pin 150 is disposed at the second position, the pin portion 155 is disposed at a position deviating from the upper portion of the stopper 115. For example, when the safety pin 150 is disposed at the second position, the pin portion 155 may be disposed at a position facing the base plate 113. In this state, the safety pin 150 may be moved in the axial direction. More specifically, the safety pin 150 may be moved in the axial direction at a distance allowing the end portion of the pin portion 155 to be brought into contact with the surface of the base plate 113. Accordingly, the knob body NB restricted by the safety pin 150 is moved in the axial direction to drive the driving shaft 71.

FIG. 21 is a perspective sectional view showing an inner structure of a fourth embodiment of the knob assembly 100 according to the present disclosure. Describing a structure different from the preceding embodiments, the knob body NB may include the locking button 140 formed integrally. The locking button 140 may be formed by cutting a portion of the knob body NB. The locking button 140 may have a kind of cantilevered structure in which a second end portion of the locking button is rotated with the first end portion fixed to the knob body NB. In the embodiment, the operating portion 143 of the locking button 140 constitutes a portion of the exterior part of the knob body NB.

The safety pin 150 may be provided integrally with a lower portion of the locking button 140. The safety pin 150 further protrudes from the lower portion of the locking button 140 toward the base portion 110. The safety pin 150 protrudes toward the stopper 115 of the base portion 110, and based on the view of FIG. 21, interferes with the stopper 115 in the axial direction. In the embodiment, the safety pin 150 is provided integrally with the locking button 140, so that the safety pin 150 and the entire locking button 140 may be considered as the safety pin.

In FIG. 21, the arrow \textcircled{1} indicates a direction of pressing and rotating the locking button 140. When the user presses the operating portion 143 of the locking button 140, the second end portion of the locking button 140 (lower end portion based on the drawing), which is not connected to the knob body NB, may be rotated to the empty space R provided in the knob body NB. In the process, the safety pin 150 is rotated together. The locking button 140 and the safety pin 150 rotated has the second position. The arrow \textcircled{2} indicates a direction of moving the safety pin 150 to the second position.

The safety pin 150 is omitted in the locking button 140, and the stopper 115 may protrude from the base portion 110. In this case, when the locking button 140 is located at the first position, the stopper 115 interferes with the surface of the locking button 140, and when the locking button 140 is located at the second position, the stopper 115 does not interfere with the surface of the locking button 140.

Meanwhile, the elastic member S may be omitted in the knob assembly 100. In this case, the user can move the locking button 140 manually from the second position to the first position. The user can pull the locking button 140 or return the locking button 140 to the first position while gripping a separate graspable structure provided in the locking button 140.

The knob body NB may include a protrusion structure having a form symmetric to the operating portion 143, at a portion opposite to the operating portion 143, based on a central portion of the knob body NB. The protrusion structure protrudes to be symmetric to the operating portion 143, increasing the user's grip feeling.

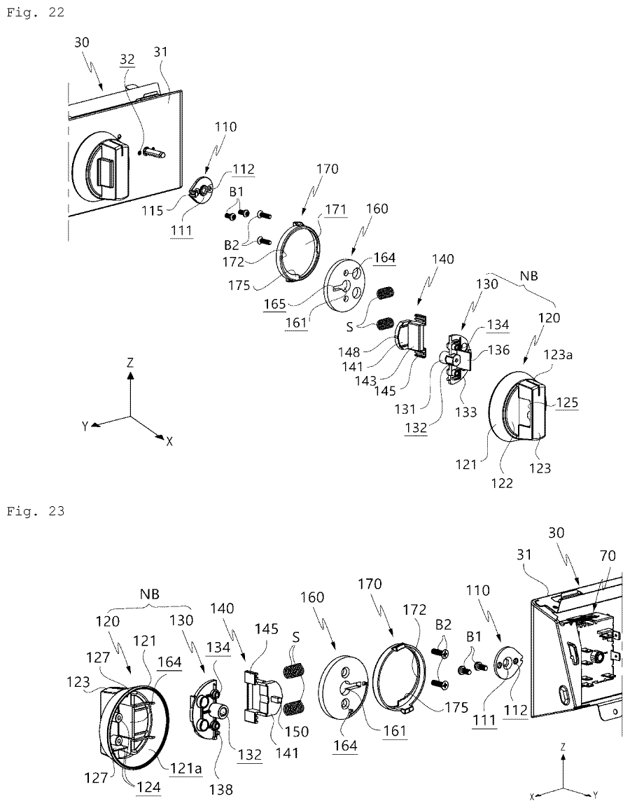

FIGS. 22 to 39 show an inner structure of a fifth embodiment of the knob assembly 100 according to the present disclosure. Hereinbelow, the description of the structure equal to the above-described embodiment will be omitted. In the embodiment, a button holder 170 is provided to restrict the locking button 140 to a specific position or remove the restriction. Hereinbelow, the knob assembly 100 will be described with the locking button 140, the button holder 170 and malfunction prevention structure.

As shown in FIGS. 22 and 23, the views show the knob assembly 100 including the button holder 170. The button holder 170 may have a ring shape. The button holder 170 may be provided to surround the weight plate 160. The button holder 170 may not be prevented from being exposed externally of the knob body NB. More specifically, when the knob assembly 100 is mounted to the control panel 30, the button holder 170 is not exposed outward. Since the knob body NB surrounds the button holder 170, the button holder 170 is prevented from being exposed. Therefore, in order to operate the button holder 170 by the user, the knob assembly 100 is separated from the driving shaft 71 first, and then the button holder 170 may be operated. This structure will be described below.

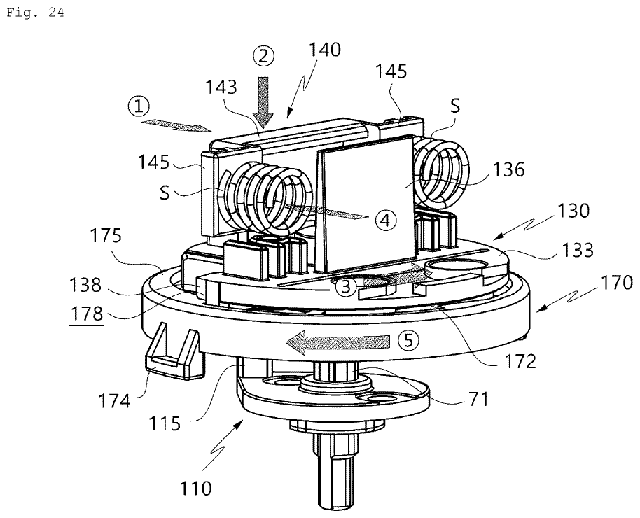

As shown in FIG. 24, the diameter of the button holder 170 may be greater than the diameter of the second knob body 130. In FIG. 24, the weight plate 160 surrounded by the button holder 170 is obscured by the button holder 170. The button holder 170 may be considered to fill a gap between the weight plate and the first knob body 120.

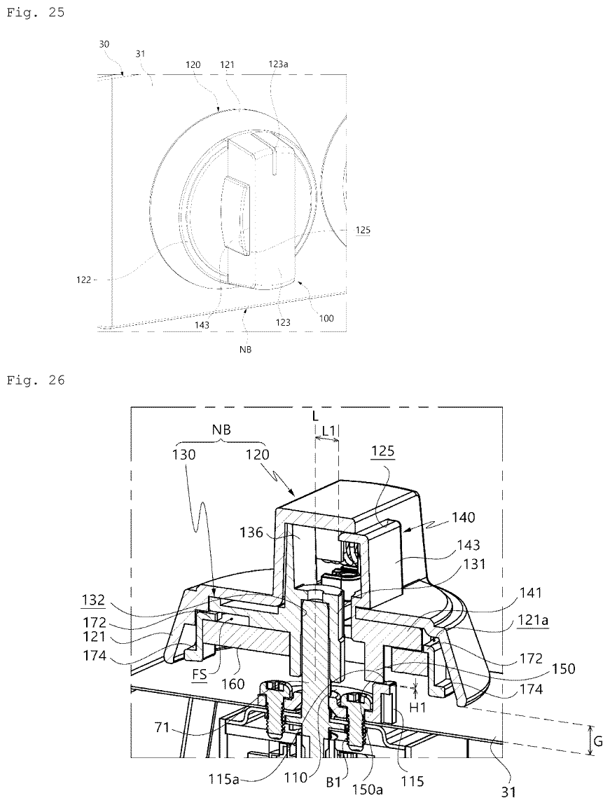

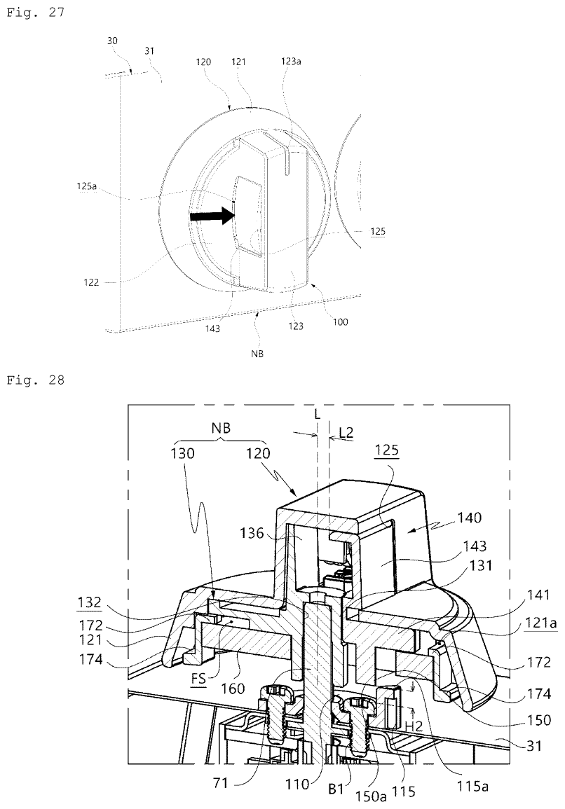

FIGS. 25 and 26 show the locking button 140 located at the knob locking position. FIGS. 27 and 28 show the locking button 140 located at the knob releasing position. In other words, when the locking button 140 at the knob locking position is pressed, the locking button 140 may be moved to the knob releasing position. The locking button 140 at the knob releasing position may be returned to the knob locking position again when the external force pressing the locking button 140 is removed. However, as described below, when the button holder 170 is moved to the button restricting position, the locking button 140 is restricted at the knob releasing position.

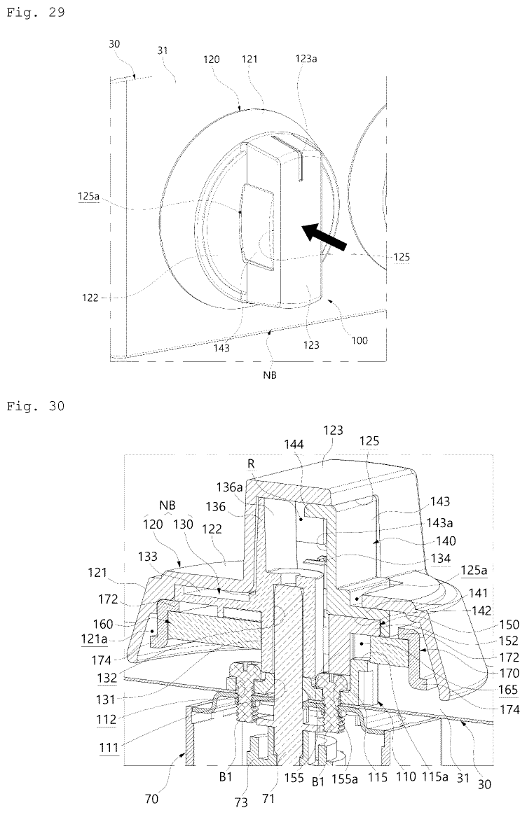

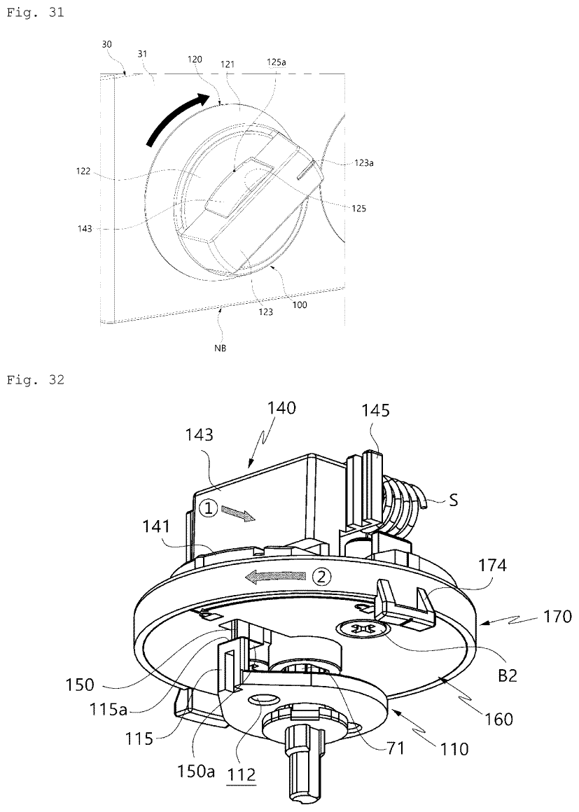

FIGS. 29 and 30 show the knob assembly 100 pressed at the knob releasing position in the axial direction and moved to the knob pressed position. At this point, since the knob assembly 100 presses the driving shaft 71 together in the axial direction, the heating device 28 can be driven. FIG. 31 shows the knob body NB rotated clockwise, and the driving shaft 71 may also be rotated clockwise with the knob body NB. As described above, when the knob body NB is rotated, the locking button 140 may be moved to the third position. The above structure has been described in the preceding embodiment, and detailed description thereof will be omitted.

As shown in FIG. 26, at the knob locking position, the locking button 140 and the base portion 110 may be spaced from each other in the axial direction at a first raising and lowering height H1. In the embodiment, at the knob locking position, the safety pin 150 and the base portion 110 are spaced from each other at the first distance H1. As shown in FIG. 28, at the knob releasing position, the locking button 140 and the base portion 110 may be spaced from each other in the axial direction at a second distance H2. In the embodiment, at the knob releasing position, the safety pin 150 and the base portion 110 are spaced from each other at the second distance H2. The second distance H2 may be formed farther than the first distance H1. For reference, in FIG. 26, the first distance H1 indicates a surface 150a of the safety pin 150 and a surface 115a of the stopper 115 provided at the base portion 110. In FIG. 28, the second distance H2 indicates a distance between the surface 150a of the safety pin 150 and the first fastener B1 fixing the base portion.

As described above, at the knob releasing position, the locking button 140 and the base portion 110 are spaced from each other at the second distance H2, and the second distance H2 is a distance of moving the locking button 140 in the axial direction. Since the locking button 140 is linearly moved with the knob body NB in the axial direction, the second distance H2 is a distance the knob body NB is movable in the axial direction. In FIG. 26, the reference numeral G indicates a distance between the knob body NB and the front plate 31. When the locking button 140 is disposed at the knob releasing position, the knob body NB and the locking button 140 may be moved together in a direction of reducing the gap G.

The locking button 140 may include a restriction support part 148. The restriction support part 148 is provided for interference with the button holder 170, and protrudes from the button body 141. The button body 141 will be described below.

Describing operations of the knob body NB and the locking button 140 with reference to FIG. 24, the locking button 140 may be pressed in the direction of the arrow \textcircled{1}. When the locking button 140 is pressed in the direction of the arrow \textcircled{1}, the locking button 140 is displaced from the knob locking position to the knob releasing position. For reference, In FIG. 24, the locking button 140 is disposed at the knob locking position so that the movement thereof in the axial direction is restricted. When the locking button 140 is moved in the direction of the arrow \textcircled{1}, excluding the base portion 110, the knob assembly 100 including the second knob body 130 may be moved in the axial direction (direction of arrow \textcircled{2}).

The knob assembly 100 moved in the axial direction as described above may be rotated in the direction of the arrow \textcircled{3}. At this point, with the second knob body 130, the first knob body 120 and the locking button 140 may also be rotated. The second knob body 130 may be rotated in a direction opposite to the direction of the arrow \textcircled{3}. Meanwhile, when the user removes the external force of pressing the locking button 140, the locking button 140 may be moved in the direction of the arrow \textcircled{4} and returned to the knob locking position by the elastic member S.

At this point, when the button holder 170 is rotated in the arrow \textcircled{5}, the button holder 170 may be disposed at the button restricting position. At the button restricting position, the button holder 170 interferes with the locking button 140, and restricts the locking button 140 from being moved to the original position, i.e., in a direction toward the knob locking position (direction of arrow \textcircled{4}). This structure will be described below in detail.

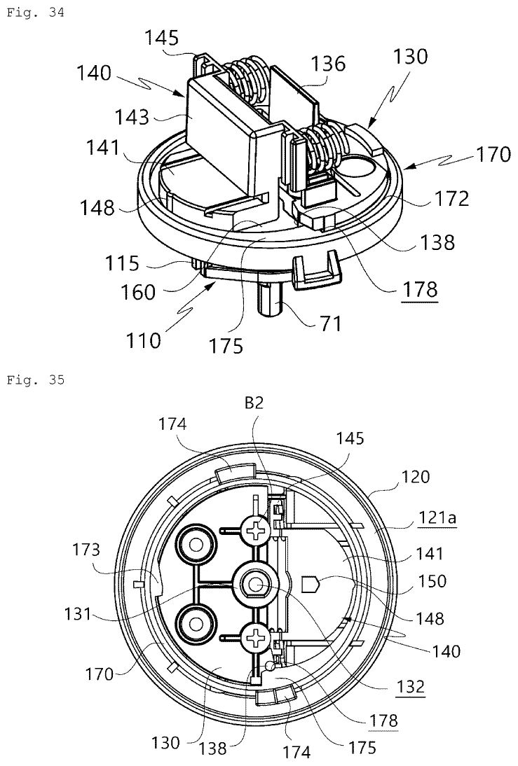

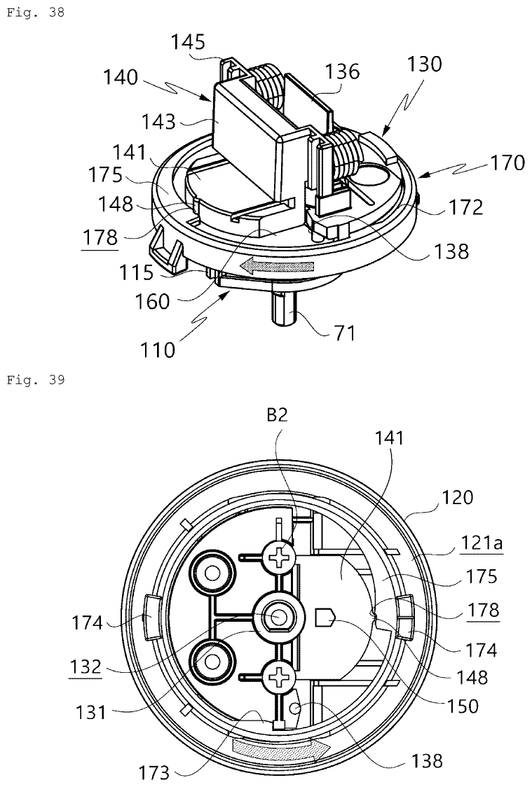

Next, the button holder 170 will be described in detail. The button holder 170 is rotatable independently from the locking button 140. In the embodiment, the button holder 170 is disposed between the weight plate 160 and the second knob body 130. The button holder 170 is guided between the weight plate 160 and the second knob body 130, and may be moved between the button releasing position (position of the button holder 170 in FIG. 34) and the button restricting position (position of the button holder 170 in FIG. 38).

The button holder 170 is rotated on a rotation center concentric to the driving shaft 71, and may restrict movement of the locking button 140. At this point, the rotation center concentric to the driving shaft 71 is a central portion of the rotation path of the button holder 170. In the embodiment, the rotation center of the button holder 170 is the same as the center of the driving shaft 71. However, the button holder 170 is not rotated on the driving shaft 71 as the rotation center, and the button holder 170 may be rotated by a guide of the weight plate 160.

When the weight plate 160 is considered as a portion of the knob body NB, the button holder 170 may be considered to be disposed at the knob body NB. As another example, the weight plate 160 is omitted, and the button holder 170 may be disposed at the knob body NB. When the button holder 170 is disposed at the knob body NB, the button holder 170 is guided by the knob body NB to be rotated and moved between the button releasing position and the button restricting position.

Meanwhile, the button releasing position indicates a state in which the locking button 140 is movable between the knob locking position and the knob releasing position. The button restricting position is a state in which the button holder 170 interferes with the locking button 140 so that the locking button 140 is restricted at a specific position. For example, when the button holder 170 is moved to the button restricting position, the locking button 140 may be restricted at the knob releasing position. As another example, when the button holder 170 is moved to the button restricting position, the locking button 140 may be restricted at the knob locking position.

As described above, in the embodiment, the button holder 170 restricts the locking button 140 at a specific position, thereby non-activating the function of the locking button 140. When the user does not want to have the function of the locking button 140, i.e., for the knob assembly 100 to have the locked state, the button holder 170 should be moved to the button releasing position. Hereinbelow, the function and the structure of the button holder 170 will be described.

The button holder 170 includes the button restricting position at which the button holder interferes with the locking button 140 to restrict movement of the locking button 140, and the button releasing position at which the button holder is rotated from the button restricting position to remove the interference with the locking button 140. The button restricting position and the button releasing position may be spaced from each other along the rotation path of the button holder 170.

At the button restricting position, the button holder 170 interferes with the locking button 140 disposed at the knob releasing position, and the locking button 140 may be restricted at the knob releasing position. As shown in FIG. 24, the locking button 140 is disposed at the knob locking position, and the safety pin 150 (not presented in FIG. 24 due to angle) may be aligned with the stopper 115 in the axial direction. At this point, FIG. 24 shows the button holder 170 disposed at the button releasing position. In this state, the button holder 170 is rotated counterclockwise (direction of arrow \textcircled{5}, thereby restricting the locking button 140 from being moved in the direction toward the knob locking position (direction of arrow \textcircled{4}).

In the embodiment, the button holder 170 is rotated in a third direction different from the first direction and the second direction that are linear directions. In other words, the button holder 170 is rotated between the button restricting position and the button releasing position. As shown in FIG. 24, the first direction is the axial direction (direction of arrow \textcircled{2}) in which the knob body NB is moved when being pushed, and the second direction is the moving direction of the locking button 140 (directions of arrows \textcircled{1} and \textcircled{4}). The third direction is a direction of rotating on a rotation center concentric to the rotation shaft. Accordingly, moving paths of the parts may be dispersed without overlapping with each other, and the parts may be efficiently disposed.

The button holder 170 may be rotated along with the knob body NB, and the button holder 170 may be rotated independently from the knob body NB. When the user rotates the knob body NB, the button holder 170 is rotated with the knob body NB. However, when the button holder 170 is rotated to the button restricting position or the button releasing position, the knob body NB and the button holder 170 may be rotated relatively to each other. This process will be described below.

The button holder 170 may be moved with the knob body NB in the axial direction along the driving shaft 71. With the knob assembly 100 mounted to the control panel 30, when the user presses the knob body NB, the button holder 170 is pressed in the axial direction with the knob body NB. This movement is possible because the button holder 170 is coupled to the knob body NB in the axial direction. More specifically, the button holder 170 is disposed between the second knob body 130 and the weight plate 160 in the axial direction, and the button holder 170 may be held in the axial direction by the second knob body 130 and the weight plate 160.

For this arrangement, in the embodiment, when the button holder 170 is assembled with the knob assembly 100, the button holder 170 is disposed at the knob body NB first, and then the weight plate 160 may be assembled thereto to overlap with the button holder 170.

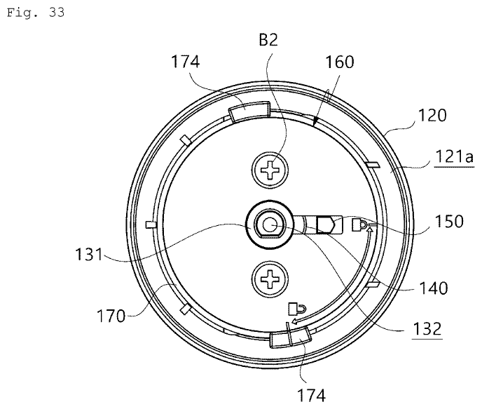

Describing the button holder 170 with reference to FIGS. 32 and 33, in FIG. 32, the locking button 140 may be linearly moved in the direction of the arrow \textcircled{1}, and the button holder 170 may be rotated in the direction of the arrow \textcircled{2}. When the button holder 170 is rotated on the rotation center concentric to the driving shaft 71, a radial length occupied by the button holder 170 in the moving path is changed. Accordingly, when the button holder 170 is rotated, an interference distance between the button holder 170 and the locking button 140 may be changed.

As shown in FIG. 33, the safety pin 150 may be linearly moved leftward in conjunction with the locking button 140, and the button holder 170 may be rotated counterclockwise. In the embodiment, a mark portion (not given reference numeral) is formed on the surface of the weight plate 160 to indicate a rotation direction of the button holder 170, the button restrictive state and button released state of the button holder 170. The user can see the mark portion to realize a current state and a rotation direction of the button holder 170.

The button holder 170 includes the button restricting position at which the button holder interferes with the locking button 140 to restrict movement of the locking button 140, and the button releasing position at which the button holder is displaced from the button restricting position to remove the interference with the locking button 140. More specifically, the button holder 170 may include the button restricting position at which the button holder is disposed in the moving path of the locking button 140 to restrict movement of the locking button 140, and the button releasing position at which the button holder deviates from the moving path of the locking button 140 to remove the interference with the locking button 140. Referring to FIG. 33 as reference, the button holder 170 is rotated counterclockwise on the shaft coupling hole 131 as the rotation center, and may enter the moving path of the locking button 140.

FIG. 32 shows the button holder 170 without interfering with the locking button 140. In FIG. 32, when the button holder 170 is rotated, the button holder 170 may fill a space emptied by the locking button 140 moved.

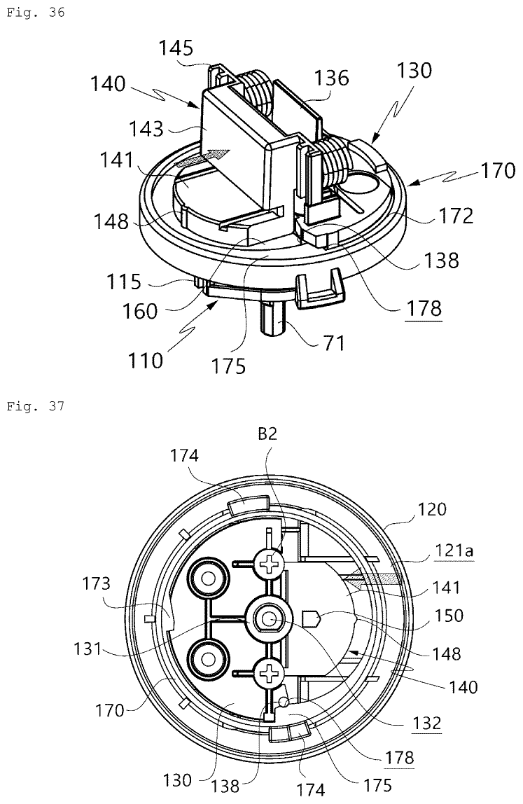

The button holder 170 may include a first rotated state in which the button holder deviates from the moving path of the locking button 140, and a second rotated state in which the button holder is rotated from the first rotated state relatively to the knob body NB. Comparing FIG. 37 of the button releasing position and FIG. 38 of the button restricting position, at the button releasing position, the button holder 170 may be in the first rotated state, and at the button restricting position, the button holder 170 may be in the second rotated state. At this point, the first rotated state and the second rotated state may have a phase difference of about 90 degrees. At this point, the button holder 170 may be rotated on the rotation center passing through the center of the axial direction. The phase difference between the first rotated state and the second rotated state does not have to be 90 degrees. For example, the button holder 170 may have a rotated angle less than 90 degrees or larger than 90 degrees.

Describing the structure of the button holder 170 in detail, the button holder 170 may include the holder body 171 (referring to FIGS. 22 and 23) having a ring shape. The holder body 171 may surround an outer circumferential surface of the weight plate 160. The holder body 171 may be rotated along the outer circumferential surface of the weight plate 160. In other words, the button holder 170 is coupled to the outer circumferential surface of the weight plate 160, and may be rotated on the weight plate 160. Referring to FIG. 26, the diameter of the holder body 171 may be greater than the diameter of the weight plate 160. At the same time, the diameter of the holder body 171 may be smaller than the diameter of a knob ring 121 of the first knob body 120. Accordingly, the holder body 171 may be surrounded by the knob ring 121 and not exposed.

The holder body 171 may include a rotation guide 172. The rotation guide 172 may protrude from an end portion of the holder body 171 toward the rotation center of the button holder 170. The rotation guide 172 is seated on a surface of the weight plate 160. Referring to FIG. 26, the rotation guide 172 is seated on an upper surface of the weight plate 160. The rotation guide 172 may prevent the button holder 170 from being separated in a direction toward the control panel 30 (downward direction of FIG. 26). The rotation guide 172 may be provided on an edge of the holder body 171 to be formed into a continuous circular shape or a discontinuous arc shape.

In the embodiment, a rotation space FS is formed between the weight plate 160 and the knob body NB. As shown in FIG. 26, the weight plate 160 and the knob body NB are spaced from each other so that the rotation space FS may be provided. A portion of the button holder 170 may be disposed in the rotation space FS. More specifically, the rotation guide 172 of the button holder 170 and a catching rib 173, which will be described below, are disposed in the rotation space FS, and the button holder 170 may be rotated along the rotation space FS. As described above, since the rotation space FS guides rotation of the button holder 170, the button holder 170 may be stably rotated while being aligned without twisting in one direction.

The central portion of the button holder 170 may be disposed between the weight plate 160 and the knob body NB in the axial direction. As shown in FIG. 33, the weight plate 160 covers a central portion of the button holder 170. The edge of the button holder 170 may be exposed toward the control panel 30. In other words, even though the weight plate 160 covers the central portion of the button holder 170, the edge portion of the button holder 170 is exposed. This is because, in the embodiment, the diameter of the button holder 170 is greater than the diameter of the weight plate 160. As another example, the diameter of the button holder 170 may be smaller than the diameter of the weight plate 160. In this case, the button holder 170 may be inserted into an arc or circular groove formed in the weight plate 160.

Referring to FIG. 35 without the weight plate 160, the button holder 170 may include the catching rib 173. The catching rib 173 may protrude more than the rotation guide 172 in a direction toward the rotation center of the button holder 170. The catching rib 173 increases an area where the button holder 170 is caught by the surface of the weight plate 160 so that the button holder 170 is stably rotated. The catching rib 173 may be disposed intermittently along the rotation guide 172.

As shown in FIGS. 32 and 33, the button holder 170 may include a holder handle 174. The holder handle 174 may protrude from the edge of the button holder 170 toward the control panel 30 in the axial direction. The holder handle 174 is a portion gripped by the user when the user rotates the button holder 170. The holder handle 174 protrudes in the axial direction and the radial direction more than the rotation guide 172, which enables the user to grip the handle easily. As another example, the holder handle 174 is omitted, and the user can rotate the entire button holder 170.

As shown in FIGS. 34 and 35, the holder body 171 may include an interfering portion 175. At the button restricting position of the button holder 170, the interfering portion 175 is disposed in the moving path of the locking button 140. The interfering portion 175 supports one portion of the locking button 140 moved toward the knob locking position, and prevents the locking button 140 from being moved in the knob releasing position.

The interfering portion 175 may have an axial thickness equal to the holder body 171. In other words, the interfering portion 175 protrudes from the ring holder body 171 toward the center of the holder body 171, but may not have a structure of protruding in the axial direction.

The button holder 170 may protrude toward the rotation center of the button holder 170 in the radial direction. When the button holder 170 protrudes in the radial direction, a facing direction of the interfering portion 175 may be changed depending on a rotation angle of the button holder 170. For example, the interfering portion 175 may be disposed in the moving path of the locking button 140 at the button restricting position of the button holder 170, and may protrude toward the locking button 140.

As shown in FIG. 35, a radially protruding length of the interfering portion 175 may extend in the circumferential direction of the button holder 170. As shown in FIG. 35, the radially protruding length of the interfering portion 175 is gradually increased in the clockwise direction. More specifically, the radially protruding length of the interfering portion 175 is increased in a direction (clockwise in FIG. 35) opposite to a direction in which the button holder 170 is rotated toward the button restrictive position (counterclockwise in FIG. 35). Then, when the button holder 170 is rotated, a force for overcoming the elastic force of the elastic member S is dispersed, and the ease of operation thereof can be improved.

At the button restricting position, the interfering portion 175 may be disposed between the locking button 140 and the knob body NB. In other words, in the radial direction, the interfering portion 175 is disposed between the locking button 140 and the first knob body 120. Referring to FIGS. 38 and 39, in the radial direction around the shaft coupling portion 131, the button body 141 of the locking button 140, the interfering portion 175, and the knob ring 121 may be disposed in order. As described above, when the interfering portion 175 is disposed between the locking button 140 and the knob body NB, the interfering portion 175 blocks a path provided for the locking button 140 to be moved to the knob locking position.

The interfering portion 175 may include a position holding portion 178 formed in the radial direction of the button holder 170. The position holding portion 178 may hold the interfering portion 175 to the button restricting position or the button releasing position. In the embodiment, the position holding portion 178 is recessed from a surface of the interfering portion 175 in the radial direction of the button holder 170. As shown in FIGS. 34 and 35, the position holding portion 178 is recessed from the outer surface of the interfering portion 175 in a direction far from the driving shaft 71.

The position holding portion 178 may be coupled to a relative holding portion 138, 148 provided in at least one of the knob body NB or the locking button 140. The relative holding portion 138, 148 may be inserted into the position holding portion 178 and hold the button holder 170 in the circumferential direction. The button holder 170 caught by the relative holding portion 138, 148 is not arbitrarily rotated in the circumferential direction, and may be rotated only by an external force applied from the user.

The relative holding portion 138, 148 may include the first relative holding portion 138 and the second relative holding portion 148. The first relative holding portion 138 is provided at a position in the knob body NB to face the position holding portion 178. The first relative holding portion 138 may be inserted into the position holding portion 178, and hold the button holder 170 to the button releasing position. As shown in FIG. 35, the first relative holding portion 138 may protrude into a cylindrical shape from a surface of the second knob body 130.

The second relative holding portion 148 may be provided in the locking button 140. The second relative holding portion 148 may protrude from the locking button 140 in the moving direction of the locking button 140. The second relative holding portion 148 at the button restricting position is coupled to the position holding portion 178 so that the button holder 170 may be held to the button restricting position. As shown in FIG. 39, the view shows the second relative holding portion 148 to which the position holding portion 178 is coupled.

As another example, the relative holding portion 138 may be provided only at the knob body NB. As another example, the relative holding portion 148 may be provided only at the locking button 140. As another example, the position holding portion 178 protrudes from the button holder 170, the first relative holding portion 138 and the second relative holding portion 148 may be recessed respectively from the second knob body 130 and the locking button 140. As another example, the position holding portion 178 is not provided at the interfering portion 175, but may be provided at the rotation guide 172.

Next, referring to FIGS. 34 to 39, a process of restricting the locking button 140 will be described. For reference, in FIGS. 35, 37, 39 of the lower surface views, the weight plate 160 is omitted to show the button holder 170.

The user can first separate the entire knob assembly 100 from the control panel 30. When the knob assembly 100 is pulled from the control panel 30 in the axial direction, the knob assembly 100 and the driving shaft 71 are separated from each other so that the knob assembly 100 is separated from the control panel 30.

FIGS. 34 and 35 shows the locking button 140 located at the knob locking position, and the button holder 170 located at the button releasing position. The interfering portion 175 of the button holder 170 is disposed at a lower part based on the drawings. In other words, the interfering portion 175 of the button holder 170 is not yet located in the moving path of the locking button 140. At this point, the position holding portion 178 of the interfering portion 175 is caught by the first relative holding portion 138 of the second knob body 130, thereby remaining held.

In this state, the user can press the locking button 140 of the separated knob assembly 100 inward (direction of arrow in FIG. 36) so that the locking button 140 may be moved to the knob releasing position. In this state, when the external force of the user pressing the locking button 140 is removed, the locking button 140 may be moved back to the knob locking position by the elastic member S.

As shown in FIG. 37, the locking button 140 is moved in the direction toward the knob releasing position (leftward direction based on the drawing) so that an empty space is formed between the button body 141 of the locking button 140 and the first knob body 120. The empty space is a space occupied by the locking button 140, and may be a portion of the moving path of the locking button 140.

While pressing the locking button 140, the user can rotate the button holder 170. More specifically, the user can rotate the button holder 170 in the direction of the arrow in FIGS. 38 and 39 while pressing the locking button 140. At this point, the user grips and holds the first knob body 120, and can grip and rotate the holder handle 174 with the other hand.

In this state, the interfering portion 175 fills the empty space between the button body 141 of the locking button 140 and the first knob body 120. In other words, the interfering portion 175 is moved to the button restricting position. When the interfering portion 175 is moved the button restricting position, the button holder 170 interferes with the button body 141 of the locking button 140, and the locking button 140 may be restricted from being moved to the knob locking position.

As described above, when the button holder 170 is rotated on the rotation center concentric to the driving shaft 71 and moved to the knob locking position, the elastic member S, the locking button 140, and the button holder 170 may be aligned in the radial direction of the knob body NB.

In detail, while overcoming an elastic force of the elastic member S and moving the button holder 170 forward (leftward direction based on FIG. 39), the user can rotate the button holder 170. When the position holding portion 178 of the interfering portion 175 reaches a position where the second relative holding portion 148 of the locking button 140 is formed, the second relative holding portion 148 is inserted naturally into the position holding portion 178 so that the position of the button holder 170 may be held.

Then, the user removes the force of pressing the button holder 170, the locking button 140 may be brought into close contact with the surface of the button holder 170 by the elastic force of the elastic member S. Accordingly, the button holder 170 may remain moved to the button restricting position.

In other words, when the button holder 170 is disposed at the button restricting position, the interfering portion 175 of the button holder 170 is brought into contact with the button body 141 and supports the locking button 140. Then, even when the elastic member S pushes the locking button 140 toward the knob locking position (rightward direction based on FIG. 39), the locking button 140 may remain at the knob releasing position by the button holder 170.

In this state, when the user couples the knob assembly 100 to the driving shaft 71 again, the knob assembly 100 may be disposed at the control panel 30. At this point, since the locking button 140 is pressed, i.e., is moved to the knob releasing position and restricted, the user does not need to press the locking button 140 to control the cooking apparatus. Therefore, the user can activate the locking button 140 by operating the button holder 170 when necessary, which increases the convenience of the knob assembly 100.

Meanwhile, unlike the above operating order, the user can rotate only the button holder 170 without pressing the locking button 140. When the user rotates only the button holder 170 without pressing the locking button 140, during rotation of the button holder 170, the inclination structure of the interfering portion 175 may press the locking button 140 from the knob locking position to the knob releasing position.

At this point, as described above, the protruding length of the interfering portion 175 is increased in a direction opposite to the direction (counterclockwise in FIG. 39) of rotating the button holder 170 toward the button restricting position. Accordingly, when the button holder 170 is rotated, the force for overcoming an elastic force of the elastic member S is dispersed, and the user can move the locking button 140 in the process of rotating the button holder 170 without applying a large amount of force.

As another example, the weight plate 160 or the knob body NB may have threads on outer circumferential surfaces thereof. The outer circumferential surface of the button holder 170 may have threads engaged with the threads of the weight plate 160 or the knob body NB. Then, the button holder 170 is rotated continuously like a screw and screw-fastened to the weight plate 160 or the knob body NB, and may have different rotation angles from each other.

As another example, the weight plate 160 is omitted, and the button holder 170 may be coupled only to the knob body NB. The button holder 170 may be rotated while being engaged with the knob body NB.

As another example, the elastic member S may be omitted in the knob assembly 100. In this case, the user can move the locking button 140 manually from the second position to the first position. The user can pull the locking button 140 or return the locking button 140 to the first position while gripping a separate graspable structure provided in the locking button 140.

As another example, the safety pin 150 is omitted in the locking button 140, and the stopper 115 may protrude from the base portion 110. In this case, when the locking button 140 is located at the first position, the stopper 115 interferes with the surface of the locking button 140, and when the locking button 140 is located at the second position, the stopper 115 does not interfere with the surface of the locking button 140.

The preceding embodiments has been described with the knob assembly 100 applied to the cooking apparatus as an example, but the knob assembly 100 may be applied to various electronics, including refrigerators, washers, dryers, hair dryers, Stylers, air conditioners, blenders, dishwashers, and the like.

Although the embodiments of the present disclosure have been described for illustrative purposes, those skilled in the art will appreciate that various modifications, additions and substitutions are possible, without departing from the scope and spirit of the present disclosure as disclosed in the accompanying claims. Therefore, the embodiments described above have been described for illustrative purposes, and should not be intended to limit the technical spirit of the present disclosure, and the scope and spirit of the present disclosure are not limited to the embodiments. The protective scope of the present disclosure should be interpreted by the accompanying claims, and all technical spirits within the equivalent scope should be interpreted as being included in the scope and spirit of the present disclosure.

What is claimed is:

1. A knob assembly comprising:
a driving shaft configured to protrude from a control panel;
a knob body configured to be rotated about the driving shaft and configured to be linearly moved in an axial direction along the driving shaft;
a locking button having an operating portion exposed externally of the knob body; and
a safety pin located at the locking button, the safety pin being configured to be operated in conjunction with the locking button, the safety pin having a first position and a second position, the second position being displaced from the first position in a direction different from the axial direction,
wherein, at the first position, the safety pin is configured to restrict an axial movement of the knob body toward the control panel, and
wherein, at the second position, the safety pin is configured to allow the axial movement of the knob body toward the control panel.

2. The knob assembly of claim 1, wherein at the first position, the safety pin is spaced a first distance in the axial direction from the control panel or a base portion configured to be located at the control panel,
wherein, at the second position, the safety pin is spaced a second distance in the axial direction from the control panel or the base portion, and
wherein the second distance is larger than the first distance.

3. The knob assembly of claim 1, wherein the safety pin is configured to be moved in the axial direction with the knob body and the locking button, and
wherein the safety pin is configured to be moved with the locking button, independently from the knob body, between the first position and the second position in the direction different from the axial direction.

4. The knob assembly of claim 1, wherein the locking button is configured to be moved, independently from the knob body, between the first position and the second position in the direction different from the axial direction, and
wherein, when the knob body is rotated about the driving shaft, the locking button is configured to be rotated along the knob body to be moved to a third position.

5. The knob assembly of claim 1, further comprising an elastic member located in the knob body, and
wherein the elastic member is configured to provide an elastic force to the locking button in a direction of displacing the locking button toward the first position.

6. The knob assembly of claim 1, wherein the safety pin protrudes from the locking button in the axial direction, and
wherein, at the second position, the safety pin is spaced in the axial direction from the control panel or a base portion configured to be located at the control panel.

7. The knob assembly of claim 1, wherein the knob body comprises an operating hole extending therethrough in a direction perpendicular to the axial direction, and
wherein the operating portion is exposed externally through the operating hole, and the operating portion forms a portion of an exterior part of the knob body.

8. The knob assembly of claim 1, further comprising a base portion configured to located at the control panel,
wherein the safety pin protrudes toward the base portion, and, at the first position, interferes with the base portion in the axial direction.

9. The knob assembly of claim 1, further comprising a base portion configured to be located at the control panel, the base having a stopper configured to interfere with the safety pin,
wherein, at the first position, the safety pin interferes with the stopper in the axial direction.

10. The knob assembly of claim 1, wherein the knob body comprises:
a first knob body having an inner space that is open toward the control panel, the first knob body having an operating hole extending therethrough to expose the operating portion of the locking button; and
a second knob body disposed in the inner space, the second knob body being configured to be rotated and linearly moved with the first knob body.

11. The knob assembly of claim 10, wherein the driving shaft comprises an end portion,
wherein the second knob body comprises a shaft coupling portion to which the end portion of the driving shaft is coupled, and
wherein a remaining portion of the second knob body excluding the shaft coupling portion and the locking button are located opposite to each other such that the shaft coupling portion is located between the locking button and the remaining portion of the second knob body.

12. The knob assembly of claim 10, further comprising a base portion configured to be located at the control panel, and
wherein the safety pin is configured to interfere with the base portion in the axial direction,
wherein the safety pin comprises:
a pin block connected to the locking button; and
a pin portion protruding from the pin block toward the base portion.

13. The knob assembly of claim 1, further comprising:
a base portion configured to be located at the control panel, and
a stopper protruding from the base portion in the axial direction,
wherein, at the first position, the safety pin and the stopper are aligned with each other in the axial direction, and
wherein, at the second position, the safety pin and the stopper are disposed to be unaligned with each other in the axial direction.

14. The knob assembly of claim 1, further comprising:
a base portion configured to be located at the control panel, and
a weight plate coupled to the knob body, the weight plate being configured to be rotated and moved with the knob body, the weight plate having a pin passing hole,
wherein the safety pin is configured to be moved between the first position and the second position while passing through the pin passing hole.

15. A knob assembly comprising:
a driving shaft configured to protrude from a control panel;
a knob body configured to be rotated about the driving shaft and configured to be linearly moved in an axial direction along the driving shaft;
a locking button configured to be moved along a moving path in a direction different from the axial direction and to restrict an axial movement of the knob body; and
a button holder located at the knob body, the button holder being configured to be rotated relative to the knob body, the button holder being configured to be rotated about a rotation center concentric with the driving shaft, and the button holder being configured to restrict movement of the locking button.

16. The knob assembly of claim 15, wherein the button holder comprises:
a button restricting position at which the button holder is configured to interfere with the locking button to restrict movement of the locking button; and
a button releasing position to which the button holder is configured to be rotated from the button restricting position such that the locking button is released.

17. The knob assembly of claim 15, wherein the locking button comprises:
a knob releasing position at which axial movement of the knob body is allowed, and
a button restricting position where the button holder is configured to interfere with the locking button located at the knob releasing position.

18. The knob assembly of claim 15, wherein the locking button comprises:
a knob locking position at which the locking button is configured to interfere with the control panel in the axial direction and restrict axial movement of the knob body; and
a knob releasing position to which the locking button is configured to be displaced from the knob locking position in a direction different from the axial direction to allow axial movement of the knob body, and
wherein the button holder is configured to be rotated to displace the locking button from the knob locking position to the knob releasing position.

19. The knob assembly of claim 15, wherein the button holder comprises:
a holder body having a ring shape; and
an interfering portion located at the holder body and at a button restricting position of the button holder, the interfering portion being configured to be located in the moving path of the locking button.

20. A cooking apparatus comprising:
a heating device; and
the knob assembly of claim 1, which is configured to operate the heating device.
